(19) United States
(12) Patent Application Publication
(10) Pub. No.: US 2017/0337578 A1
(43) Pub. Date: Nov. 23, 2017

(54) DYNAMIC MEDIA BUY OPTIMIZATION USING ATTRIBUTION-INFORMED MEDIA BUY EXECUTION FEEDS

(71) Applicants: Anto Chittilappilly, Waltham, MA (US); Parameshvyas Laxminarayan, Needham, MA (US); Payman Sadegh, Alpharetta, GA (US); Philip Gross, Newton, MA (US)

(72) Inventors: Anto Chittilappilly, Waltham, MA (US); Parameshvyas Laxminarayan, Needham, MA (US); Payman Sadegh, Alpharetta, GA (US); Philip Gross, Newton, MA (US)

(21) Appl. No.: 15/491,908

(22) Filed: Apr. 19, 2017

Related U.S. Application Data
(60) Provisional application No. 62/324,787, filed on Apr. 19, 2016.
(60) Provisional application No. 62/324,568, filed on Apr. 19, 2016.

(51) Int. Cl. G06Q 30/02

(52) U.S. Cl. CPC G06Q 30/0249; G06Q 30/0246

(57) ABSTRACT

Touchpoint encounters, which represent exposure to messages transmitted through a network to users, include attributes that define universal unique identifiers (UUIDs) for user devices and at least one cross-device user engagement stack. The cross-device user engagement stack consolidates the touchpoint encounters from the user devices with different UUIDs but associated with a single user. A stimulus attribution predictive model outputs attribution parameters to estimate an effectiveness of the messages to elicit positive responses from the users. Media buy execution feed parameters are generated to quantify a set of spending amounts, based on the attribution parameters, so as to specify a cost-effective amount to deliver one of the messages to the users. The media buy execution feed parameters are delivered to programmatic media buying execution platforms that attempt to deliver the messages in accordance with the spending amounts.

### RELATED APPLICATIONS

The present application claims the benefit of priority to co-pending U.S. Patent Application Ser. No. 62/324,787, entitled “CROSS-DEVICE MARKETING TOUCHPOINT ATTRIBUTION” (Attorney Docket No VISQ.P0029P), filed Apr. 19, 2016, and to co-pending U.S. Patent Application Ser. No. 62/324,568, entitled “DYNAMIC MEDIA BUY OPTIMIZATION USING ATTRIBUTION-INFORMED MEDIA BUY EXECUTION FEEDS” (Attorney Docket No. VISQ.P0030P), filed Apr. 19, 2016, both of which are hereby incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosure relates to the field of media spend management and more particularly to techniques for dynamic media buy optimization using attribution-informed media buy execution feeds.

### BACKGROUND

The ever-prevalent and ever-expanding Internet web that enables the digital advertising ecosystem offers advertisers numerous ad content choices for stimulating a target audience (e.g., to generate brand awareness, and/or to invoke a certain response). Specifically, an online user (e.g., prospect) in a given target audience can experience a high number of exposures (e.g., touchpoints) to brands and products across multiple digital media channels (e.g., display, paid search, paid social, etc.) and across multiple devices (e.g., desktop computer, tablet, mobile phone, etc.). Unlike in legacy advertising, a sequence of exposures on a user's journey to conversion (e.g., buying a product, etc.) and/or to some other engagement state (e.g., brand introduction, brand awareness, etc.) can be tracked, measured and optimized. Accordingly an ecosystem layer of buyers and sellers of such various forms of media has evolved along with the growth of the Internet. On the sell side are publishers (e.g., Yahoo!, ESPN, etc.) who represent the assets, capabilities, and audiences of the content. Publishers for online or digital media channels can be challenged by uncertainty in the makeup of their ad inventory and/or in selling out their ad inventory, resulting in dynamic ad pricing and/or availability. Ad networks help mitigate such uncertainty by aggregating global ad inventory (e.g., impressions) collected from the Internet based on context, audience, and/or other characteristics, to enable a more efficient market for media sellers (e.g., publishers) and media buyers (e.g., advertisers). In some cases, the market transactions are through digital media exchanges or ad exchanges. Demand-side platforms (DSPs) further leverage networking and computing technology to improve digital advertising market efficiency by accessing ad inventory (e.g., through ad networks, ad exchanges, etc.) and placing the buys on behalf of the advertiser. In some cases, the media buys can be programmatically executed by the platforms using computer technology. Professional marketing managers for the advertisers are often tasked with providing direction to multiple such programmatic media buying execution platforms (e.g., demand-side platforms (DSPs), etc.) for allocating large budgets (e.g., millions of dollars) of media spend among this massive set of advertising choices. This task might compel the marketing manager to want to be able to predict the performance of a media spend plan so as to direct the programmatic media buying execution platforms based on predicted performance.

Certain touchpoint response predictive modeling techniques can collect user level stimulus and response data (e.g., touchpoint attribute data, conversion data, etc.) that can then serve to predict the performance (e.g., contribution value, lift, CPA, etc.) of every touchpoint and/or touchpoint attribute (e.g., ad size, placement, publisher, creative, offer, etc.) experienced by every converting user and non-converting user across all channels. Systems implementing such predicted media performance metrics (e.g., attribution) can be used by the marketing manager to analyze the performance of historical media spend plans and/or develop new media spend plans. Unfortunately, such systems are limited at least in their ability to dynamically deliver performance parameters and/or spend parameters to multiple programmatic media buying execution platforms to facilitate the execution of media spend plans.

Techniques are needed to address the problem of dynamically delivering performance and/or spend parameters to multiple programmatic media buying execution platforms to facilitate the execution of media spend plans.

None of the aforementioned legacy approaches achieve the capabilities of the herein-disclosed techniques for dynamic media buy optimization using attribution-informed media buy execution feeds. Therefore, there is a need for improvements.

### BRIEF DESCRIPTION OF THE DRAWINGS

FIG. 1A depicts techniques for dynamic media buy optimization using attribution-informed media buy execution feeds, according to an embodiment.

FIG. 1B shows an environment in which embodiments of the present disclosure can operate.

FIG. 2 depicts an environment 600 in which embodiments of the present disclosure can operate.

FIG. 3A presents an input parameter generation technique used to generate media buy execution feeds in systems for dynamic media buy optimization using attribution-informed media buy execution feeds, according to some embodiments.

FIG. 3B presents a touchpoint attribute chart showing sample attributes associated with touchpoints of a media campaign, according to some embodiments.

FIG. 3C illustrates a touchpoint attribution technique, according to some embodiments.

FIG. 4A illustrates a scenario for cross-device marketing touchpoint attribution, according to some embodiments.

FIG. 4B shows an environment in which embodiments of the present disclosure can operate.

FIG. 5 presents a cross-device engagement stack joining technique used in systems for cross-device marketing touchpoint attribution, according to some embodiments.

FIG. 6A depicts a subsystem for cross-device marketing touchpoint attribution, according to some embodiments.

FIG. 6B presents a flow chart for cross-device marketing touchpoint attribution, according to some embodiments.

FIG. 7A presents a channel attribution metrics interface used in systems for cross-device marketing touchpoint attribution, according to some embodiments.

FIG. 7B presents a device attribution metrics interface used in systems for cross-device marketing touchpoint attribution, according to some embodiments.

FIG. 7C presents a category lift metrics interface used in systems for cross-device marketing touchpoint attribution, according to some embodiments.

FIG. 8 presents a media buy execution feed generation technique used in systems for dynamic media buy optimization using attribution-informed media buy execution feeds, according to some embodiments.

FIG. 9A depicts an attribution-informed placement feed data structure used in systems for dynamic media buy optimization using attribution-informed media buy execution feeds, according to some embodiments.

FIG. 9B depicts an attribution-informed touchpoint feed data structure used in systems for dynamic media buy optimization using attribution-informed media buy execution feeds, according to some embodiments.

FIG. 9C depicts an attribution-informed touchpoint spend feed data structure used in systems for dynamic media buy optimization using attribution-informed media buy execution feeds, according to some embodiments.

FIG. 10A depicts a subsystem for dynamic media buy optimization using attribution-informed media buy execution feeds, according to some embodiments.

FIG. 10B presents a feed refresh technique for dynamic media buy optimization using attribution-informed media buy execution feeds, according to some embodiments.

FIG. 11A presents a feed schedule interface used in systems for dynamic media buy optimization using attribution-informed media buy execution feeds, according to some embodiments.

FIG. 11B presents a feed format interface used in systems for dynamic media buy optimization using attribution-informed media buy execution feeds, according to some embodiments.

FIG. 11C presents a feed report interface used in systems for dynamic media buy optimization using attribution-informed media buy execution feeds, according to some embodiments.

FIG. 11D presents a feed filter interface used in systems for dynamic media buy optimization using attribution-informed media buy execution feeds, according to some embodiments.

FIG. 11E presents a feed destination interface used in systems for dynamic media buy optimization using attribution-informed media buy execution feeds, according to some embodiments.

FIG. 12 is a block diagram of a system for dynamic media buy optimization using attribution-informed media buy execution feeds, according to an embodiment.

FIG. 13A and FIG. 13B depict block diagrams of computer system components suitable for implementing embodiments of the present disclosure.

### DETAILED DESCRIPTION

### Overview

Certain touchpoint response predictive modeling techniques can collect user level stimulus and response data (e.g., touchpoint attribute data, conversion data, etc.) to predict the performance (e.g., contribution value, lift, CPA, etc.) of every touchpoint and/or touchpoint attribute (e.g., ad size, placement, publisher, creative, offer, etc.) experienced by every converting user as well as by every non-converting user across all channels. Systems implementing such predicted media performance metrics (e.g., attribution) can be used by the marketing manager to analyze the performance of historical media spend plans and/or develop new media spend plans.

Disclosed herein are techniques to deliver performance parameters and/or spend parameters to multiple programmatic media buying execution platforms to facilitate the execution of media spend plans. One specific technique implements a media buy feed generator configured to use media performance parameters and/or allocated media buy parameters to generate attribution-informed media buy execution feeds, which in turn can be delivered to any number of programmatic media buying execution platforms (e.g., demand-side platforms). The media performance parameters (e.g., characterizing fractional touchpoint attribution metrics) can be derived from a predictive model formed from empirically-collected historical media stimulus and response data taken from user interactions on the Internet. The media buy execution feeds can be dynamically generated based on media performance parameters determined from the most recent sets of stimulus and/or response data collected from the Internet. Feed configuration parameters and/or media spend allocation parameters used to derive the allocated media buy parameters can be used in conjunction with a media planning application such as a media planning application operated by a marketing manager.

### Definitions

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances
The articles “a” and “an” as used in this application and the appended claims should generally be construed to mean “one or more” unless specified otherwise or is clear from the context to be directed to a singular form.

### Solutions Rooted in Technology

The appended figures corresponding discussion given herein provides sufficient disclosure to make and use systems, methods, and computer program products that address the aforementioned issues with legacy approaches. More specifically, the present disclosure provides a detailed description of techniques used in systems, methods, and in computer program products for dynamic media buy optimization using attribution-informed media buy execution feeds. Certain embodiments are directed to technological solutions for dynamically generating attribution-informed media buy execution feeds for one or more programmatic media buying execution platforms based on media performance parameters and/or allocated media buy parameters, which embodiments advance the relevant technical fields, as well as advancing peripheral technical fields. The disclosed embodiments modify and improve over legacy approaches. In particular, the herein-disclosed techniques provide technical solutions that address the technical problems attendant to dynamically delivering performance and/or spend parameters to multiple programmatic media buying execution platforms to facilitate rapid adjustments pertaining to ongoing execution of media spend plans. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high-performance Internet advertising as well as advances in various technical fields related to machine learning.

Reference is now made in detail to certain embodiments. The disclosed embodiments are not intended to be limiting of the claims.

### DESCRIPTIONS OF EXEMPLARY EMBODIMENTS

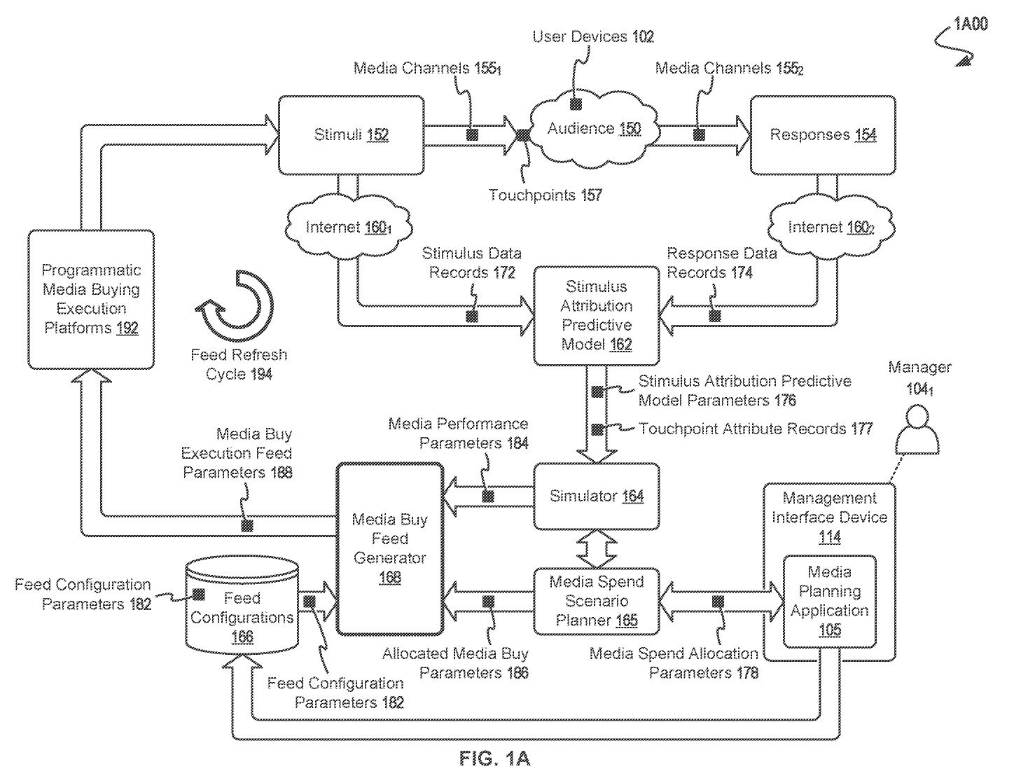

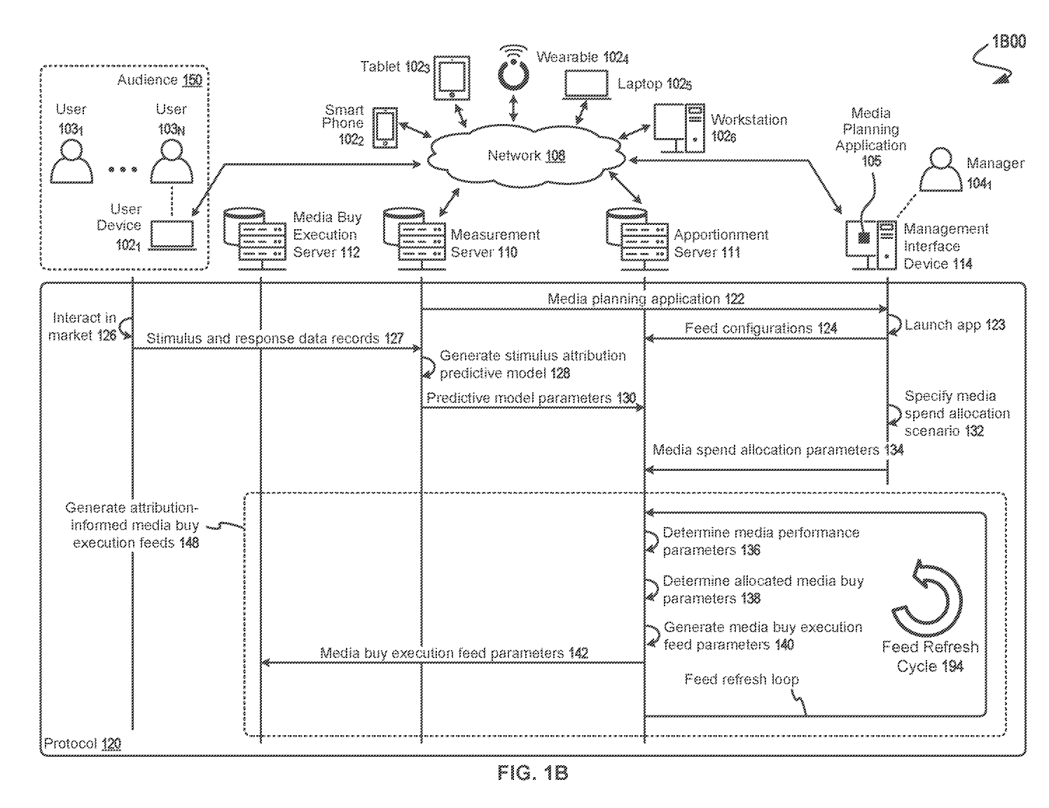

FIG. 1A depicts techniques 1A00 for dynamic media buy optimization using attribution-informed media buy execution feeds. As an option, one or more instances of techniques 1A00 or any aspect thereof may be implemented in the context of the architecture and functionality of the embodiments described herein. Also, the techniques 1A00 or any aspect thereof may be implemented in any desired environment.

As shown in FIG. 1A, a set of stimuli 152 is presented to an audience 150 (e.g., as part of a marketing campaign), that further produces a set of responses 154. For example, the stimuli 152 might be part of a marketing campaign developed by a marketing manager (e.g., manager 104₁) to reach the audience 150 with the objective to generate user conversions (e.g., sales of a certain product). The stimuli 152 is delivered to the audience 150 through certain instances of media channels 155₁ that can comprise digital or online media channels (e.g., online display, online search, paid social media, email, etc.). The media channels 155₁ can further comprise non-digital or offline media channels (e.g., TV, radio, print, etc.). The audience 150 is exposed to each stimulation comprising the stimuli 152 through a set of touchpoints 157 characterized by certain respective attributes. The responses 154 can also be delivered through other instances of media channels 155₂ that can further comprise online and offline media channels. In some cases, the information indicating a particular response can be included in the attribute data associated with the instance of the touchpoints 157 to which the user is responding. The portion of stimuli 152 delivered through online media channels can be received by the users comprising audience 150 at various instances of user devices 102 (e.g., mobile phone, laptop computer, desktop computer, tablet, etc.). Further, the portion of responses 154 received through digital media channels can also be invoked by the users comprising audience 150 using the user devices 102.

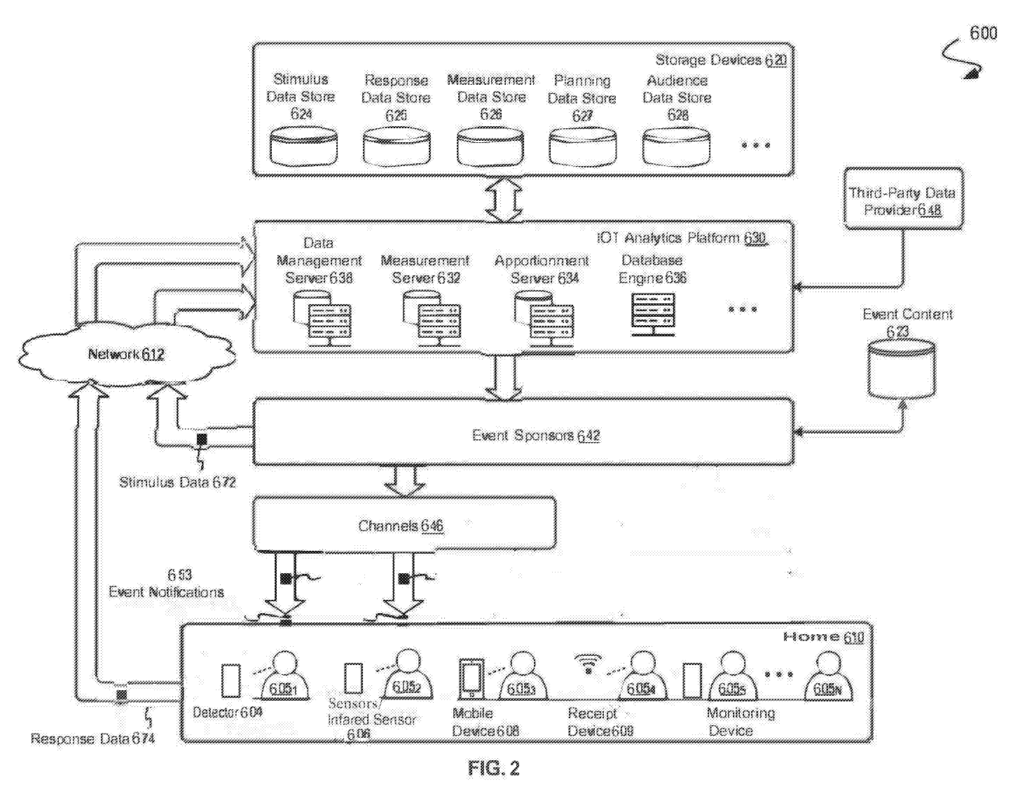

As further shown, a set of stimulus data records 172 and a set of response data records 174 can be received over a network (e.g., Internet 160₁ and Internet 160₂, respectively) to be used to generate a stimulus attribution predictive model 162. The stimulus attribution predictive model 162 can be used to estimate the effectiveness of each stimulus in a certain marketing campaign by attributing credit to respective stimuli in achieving the desired responses of the campaign. The stimulus attribution predictive model 162 can be formed using any machine learning techniques (e.g., see FIG. 2A) to accurately model the relationship between the stimuli 152 and the responses 154. For example, weekly summaries of the stimulus data records 172 and the response data records 174 over a certain historical period (e.g., last six months) can be used to generate the stimulus attribution predictive model 162. When formed, the stimulus attribution predictive model 162 can be described in part by certain model parameters (e.g., input variables, output variables, equations, equation coefficients, mapping relationships, limits, constraints, etc.) comprising the stimulus attribution predictive model parameters 176 that can be used for determining effectiveness metrics that correspond to marketing message placements, as well as for various other purposes as discussed herein.

Specifically, a simulator 164 might be used in combination with the stimulus attribution predictive model 162 to estimate the temporal attribution (e.g., contribution value) of each stimulus, stimulus attribute (e.g., touchpoint attribute), and/or group of stimuli (e.g., a channel from the media channels 155₁) characterized by the stimulus data records 172 to the responses (e.g., conversions) characterized by the response data records 174. In some cases, the simulator 164 can use a set of touchpoint attribute records 177 derived from the stimulus data records 172 and/or the response data records 174 to run a sensitivity analysis on each touchpoint to determine the touchpoint attribution. Such media performance metrics might be characterized in a set of media performance parameters 184. In some cases, the media performance parameters 184 can characterize a measure of the influence that can be attributed to the stimulus, stimulus attribute, and/or group of stimuli in transitioning one or more users from one engagement state to another engagement state. A media spend scenario planner 165 can further use the stimulus attribution predictive model 162 and/or the simulator 164 to enable the manager 104₁ to select a media spend allocation plan for a given marketing campaign. For example, a media planning application 105 can be provided to an application user (e.g., manager 104₁) for operation on a management interface device 114 (e.g., laptop computer) to facilitate such media planning. Specifically, the manager 104₁ might specify certain sets of media spend allocation parameters 178 corresponding to media spend scenarios of interest to the manager 104₁. The media spend scenario planner 165 can determine certain instances of allocated media buy parameters 186 associated with a selected one or more of the media spend scenarios.

In some cases, the manager 104₁ might want to use the media performance parameters 184 and/or the allocated media buy parameters 186 to direct the programmatic media buying execution platforms (e.g., DSPs) the manager 104₁ uses for executing media campaigns. According to the herein disclosed techniques, the media buy feed generator 168 can be used to address the problems dynamically delivering performance and/or spend parameters to multiple programmatic media buying execution platforms to facilitate the execution of media spend plans. Specifically, the media buy feed generator 168 can use the media performance parameters 184 and/or the allocated media buy parameters 186 to generate attribution-informed feeds comprising sets of media buy execution feed parameters 188 to deliver to the programmatic media buying execution platforms 192. In some embodiments, the media buy execution feed parameters 188 can be configured (e.g., structured, scheduled, etc.) according to various sets of feed configuration parameters 182 stored in feed configurations 166. In some cases, the manager 104₁ can specify the feed configuration parameters 182 from the media planning application 105. Further, the media buy execution feed parameters 188 and/or delivery of the associated feeds to the programmatic media buying execution platforms 192 can be dynamically responsive to various events in a feed refresh cycle 194. For example, such events might include a scheduled refresh specified in the feed configurations 166. In some cases, the event might invoke the collection of additional stimulus and/or response data from the Internet.

The herein-disclosed technological solution described by the techniques 1A00 in FIG. 1A can be implemented in various network computing environments and associated online and offline marketplaces. Such an environment is discussed as pertains to FIG. 1B.

FIG. 1B shows an environment 1B00 in which embodiments of the present disclosure can operate.

As shown in FIG. 1B, the environment 1B00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1B00 comprises at least one instance of a measurement server 110, at least one instance of an apportionment server 111, at least one instance of a media buy execution server 112, and at least one instance of the management interface device 114. The servers and devices shown in environment 1B00 can represent any single computing system with dedicated hardware and software, multiple computing systems clustered together (e.g., a server farm, a host farm, etc.), a portion of shared resources on one or more computing systems (e.g., a virtual server), or any combination thereof. In one or more embodiments, the media buy execution server 112 can represent an entity (e.g., demand-side platform) in an online advertising ecosystem that might facilitate the execution of a media buy plan. The media buy execution server 112 might further represent any data consumer with use for the media buy execution feed parameters (e.g., media buy execution feed parameters 188) produced by the herein disclosed techniques. Such data consumers might include trading desks, campaign management platforms, search marketing bidding tools, customer relationship management (CRM) systems, real-time bidding (RTB) platforms, and/or other data consumers.

The environment 1B00 further comprises at least one instance of a user device 102₁ that can represent one of a variety of other computing devices (e.g., user devices 102, a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102 can be operated by a user 103_{N}. Other users (e.g., user 103₁) with or without a corresponding user device can comprise the audience 150. Also, as earlier described in FIG. 1A, the media planning application 105 can be operating on the management interface device 114 and accessible by the manager 104₁.

As shown, the user 103₁, the user device 102₁ (e.g., operated by user 103_{N}), the measurement server 110, the apportionment server 111, the media buy execution server 112, and the management interface device 114 (e.g., operated by the manager 104) can exhibit a set of high-level interactions (e.g., operations, messages, etc.) in a protocol 120. Specifically, the protocol can represent interactions in systems for dynamic media buy optimization using attribution-informed media buy execution feeds. As shown, the manager 104₁ can download the media planning application 105 from the measurement server 110 to the management interface device 114 (see message 122) and launch the application (see operation 123). The manager 104₁ might then use the media planning application 105 to select and upload one or more sets of feed configurations to the apportionment server 111 (see message 124). Users in audience 150 can also interact with various marketing campaign stimuli delivered through certain media channels (see operation 126), such as taking one or more measurable actions in response to such stimuli and/or other non-media effects. Information characterizing the stimuli and responses of the audience 150 can be collected as stimulus data records (e.g., stimulus data records 172) and response data records (e.g., response data records 174) by the measurement server 110 (see message 127). Using the stimulus and response data, the measurement server 110 can generate a stimulus attribution predictive model (see operation 128), such as stimulus attribution predictive model 162. The model parameters characterizing the aforementioned generated predictive model can be availed to the apportionment server 111 (see message 130). The manager 104₁ might further use the media planning application 105 to specify a media spend allocation scenario (see operation 132) characterized by a set of media spend allocation parameters received by the apportionment server 111 (see message 134).

As highlighted in the protocol 120, a grouping 148 can represent one embodiment of certain messages and operations used to generate attribution-informed media buy execution feeds for dynamic media buy optimization according to the herein disclosed techniques. Specifically, such a grouping of interactions might commence with using the stimulus attribution predictive model (e.g., stimulus attribution predictive model 162) and/or other components (e.g., simulator 164) to determine a set of media performance parameters (see operation 136). For example, performance parameters relating to certain metrics (e.g., attribution, conversions, impressions, CPA, etc.) of the media (e.g., channels, stimuli, touchpoints, touchpoint attributes, etc.) corresponding to a certain campaign, time period, and/or other dimension might be determined. Further, certain allocated media buy parameters can be determined at the apportionment server 111 (see operation 138). For example, certain buy parameters (e.g., total budget, max bid price, etc.) for the various media (e.g., channels, stimuli, touchpoints, touchpoint attributes, etc.) associated with the media spend scenario from the manager 104₁ might be determined. Using such media performance parameters and/or such allocated media buy parameters, a set of media buy execution feed parameters can be generated (see operation 140). In some cases, the feed configurations provided by the manager 104₁ can further be used to generate the media buy execution feed parameters and/or the associated feeds. For example, the feed configurations might specify the characteristics (e.g., structure, timing, etc.) of the feed comprising the media buy execution feed parameters such that the feed can be successfully (e.g., without error) received by the media buy execution server 112 (see message 142).

According to the herein disclosed technological solution, such feeds can be dynamically generated and delivered to multiple data consumers over the Internet responsive to the continuous stream of online stimulus and response data. Specifically, such dynamic response is illustrated by the feed refresh cycle 194 shown in FIG. 1B. For example, the feed refresh cycle 194 might be invoked to generate the media buy execution feed parameters responsive to determining the media performance parameters (e.g., an updated performance snapshot based on the latest data), and/or responsive to a refresh cycle signal (e.g., triggered by the feed configuration schedule). In some cases, the feed refresh cycle 194 might further include collecting additional stimulus and/or response data records (see message 127). In other cases, the feed refresh cycle 194 might further include updating the stimulus attribution predictive model (see operation 128). Other operations (e.g., performance interpolation) might also be included in feed generation and/or feed refresh techniques.

FIG. 2 depicts an environment 600 in which embodiments of the present disclosure can operate. As an option, one or more instances of environment 600 or any aspect thereof may be implemented in the context of the architecture and functionality of the embodiments described herein. Also, the environment 600 or any aspect thereof may be implemented in any desired environment.

The present invention has application for systems that utilize the Internet of Things (IOT). For these embodiments, systems communicate to environments, such as a home environment, to employ event campaigns that use stimuli to effectuate desired user responses. Specifically, devices may be placed in the home to both communicate event messages or notifications as well as receive responses, either responses gathered by sensing users or by direct input to electronic devices by the users. Embodiments for implementing the present invention in such an environment are shown in FIG. 2.

The shown environment 600 depicts a set of users (e.g., user 605₁, user 605₂, user 605₃, user 605₄, user 605₅, to user 605_{N}) comprising an audience 610 that might be targeted by one or more event sponsors 642 in various event campaigns. The users may view a plurality of event notifications 653 on a reception device 609 (e.g., desktop PC, laptop PC, mobile device, wearable, television, radio, etc.). The event notifications 653 can be provided by the event sponsors 642 through any of a plurality of channels 746 in the wired environment (e.g., desktop PC, laptop PC, mobile device, wearable, television, radio, print, etc.). Stimuli from the channels 646 comprise instances of touchpoints 660 experienced by the users. As an example, a TV spot may be viewed on a certain TV station (e.g., touchpoint T1), and/or a print message (e.g., touchpoint T2) in a magazine. Further, the stimuli channels 746 might present to the users a banner ad on a mobile browser (e.g., touchpoint T3), a sponsored website (e.g., touchpoint T4), and/or an event notification in an email message (e.g., touchpoint T5). The touchpoints 660 can be described by various touchpoint attributes, such as data, time, campaign, event, geography, demographics, impressions, cost, and/or other attributes.

According to one implementation, an IOT analytics platform 630 can receive instances of stimulus data 672 (e.g., stimulus touchpoint attributes, etc.) and instances of response data 674 (e.g., response measurement attributes, etc.) via network 612, describing, in part, the measured responses of the users to the delivered stimulus (e.g., touchpoints 660). The measure responses are derived from certain user interactions as sensed in the home (e.g., detector 604, sensor/infrared sensor 606, or monitoring device 611) or transmitted by the user (e.g., mobile device 611, etc.) performed by certain users and can be described by various response attributes, such as data, time, response channel, event, geography, revenue, lifetime value, and other attributes. A third-party data provider 648 can further provide data (e.g., user behaviors, user demographics, cross-device mapping, etc.) to the IOT analytics platform 630. The collected data and any associated generated data can be stored in one or more storage devices 620 (e.g., stimulus data store 624, response data store 625, measurement data store 626, planning data store 627, audience data store 628, etc.), which are made accessible by a database engine 636 (e.g., query engine, result processing engine, etc.) to a measurement server 632 and an apportionment server 634. Operations performed by the measurement server 632 and the apportionment server 634 can vary widely by embodiment. As an example, the measurement server 632 can be used to analyze certain data records stored in the stimulus data store 624 and response data store 625 to determine various performance metrics associated with an event campaign, storing such performance metrics and related data in measurement data store 626. Further, for example, the apportionment server 634 may be used to generate event campaign plans and associated event spend apportionment, storing such information in the planning data store 627.

As described in FIG. 1A and FIG. 1B, the techniques disclosed herein are facilitated, in part, by the input parameters (e.g., media performance parameters 184, allocated media buy parameters 186) availed to the media buy feed generator 168 (e.g., at the apportionment server 111). More details pertaining to the generation of such input parameters are discussed in the following and herein.

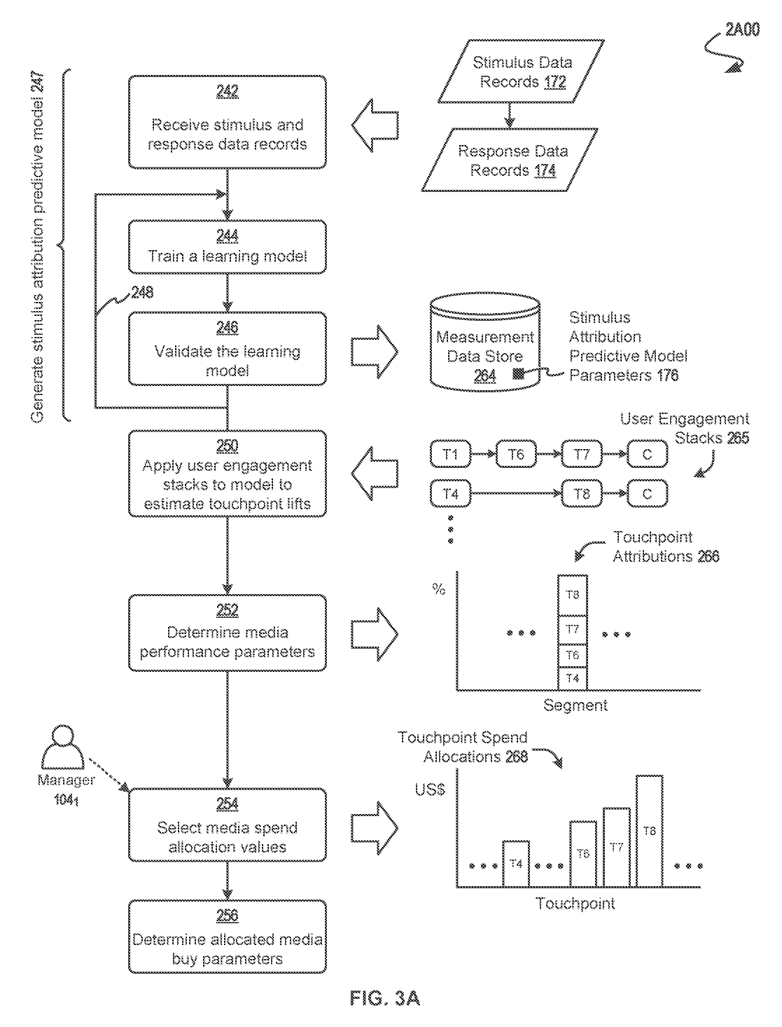

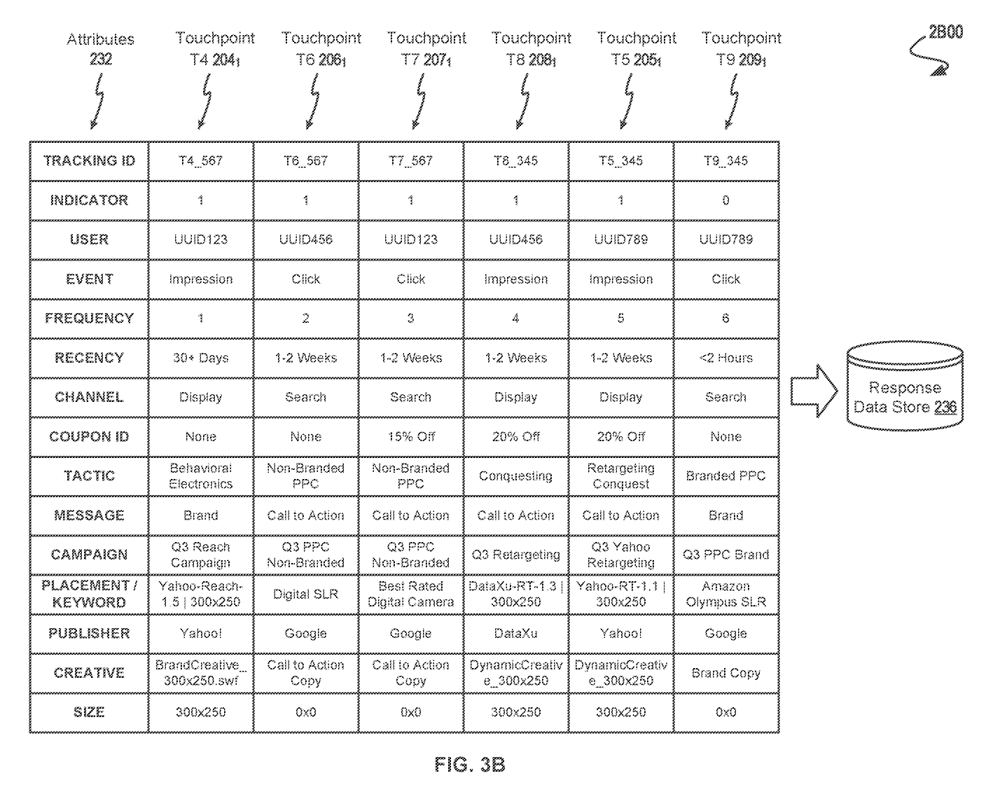

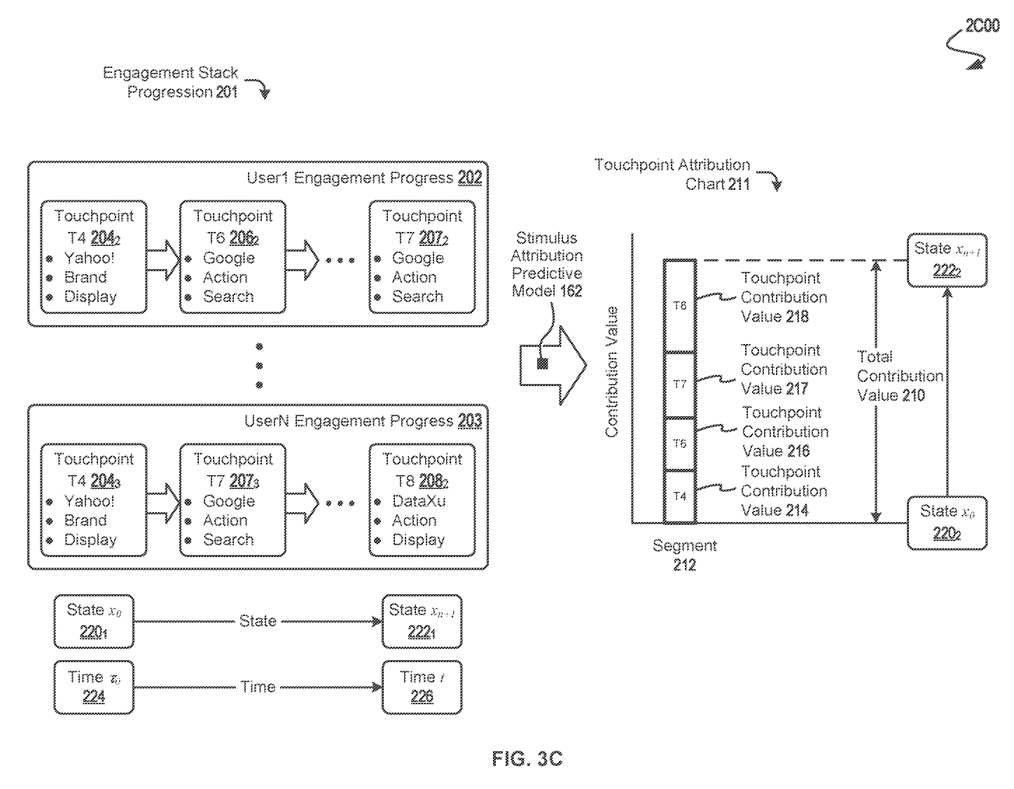

FIG. 3A presents an input parameter generation technique 2A00 used in systems for dynamic media buy optimization using attribution-informed media buy execution feeds. As an option, one or more instances of input parameter generation technique 2A00 or any aspect thereof may be implemented in the context of the architecture and functionality of the embodiments described herein. Also, the input parameter generation technique 2A00 or any aspect thereof may be implemented in any desired environment.

FIG. 3A depicts process steps used in the generation of certain input parameters (e.g., media performance parameters 184, allocated media buy parameters 186) used by the herein disclosed techniques for dynamic media buy optimization using attribution-informed media buy execution feeds. As shown, stimulus data records 172 and response data records 174 associated with one or more historical marketing campaigns and/or time periods are received by a computing device and/or system (e.g., measurement server 110) over a network (see step 242). The information associated with the stimulus data records 172 and response data records 174 can be organized in various data structures. A portion of the collected stimulus and response data can be used to train a learning model (see step 244). A different portion of the collected stimulus and response data can be used to validate the learning model (see step 246). The processes of training and/or validating can be iterated (see path 248) until the learning model behaves within target tolerances (e.g., with respect to predictive statistic metrics, descriptive statistics, significance tests, etc.). In some cases, additional historical stimulus and response data can be collected to further train and/or validate the learning model. The foregoing steps might generate a stimulus attribution predictive model (see grouping 247). When such a learning model has been generated, a set of stimulus attribution predictive model parameters 176 (e.g., input variables, output variables, equations, equation coefficients, mapping relationships, limits, constraints, etc.) describing the learning model can be stored in a measurement data store 264 for access by various computing devices (e.g., measurement server 110, management interface device 114, apportionment server 111, etc.).

For example, certain user engagement stacks (e.g., user engagement stacks 265) comprising a time series of touchpoints might be applied to the learning model (e.g., stimulus attribution predictive model 162) to estimate the touchpoint lifts (see step 250) contributing to conversions, brand engagement events, and/or other events. A set of media performance parameters can then be determined (see step 252), characterizing, for example, the fractional attributions (e.g., contribution values) of all the touchpoints for a given segment of users and/or media channel. Such media performance parameters might be used to generate a chart showing the touchpoint attributions 266 for a given segment. Specifically, a percentage attribution for a touchpoint T4, a touchpoint T6, a touchpoint T7, and a touchpoint T8 can be determined for the segment (e.g., all users, male users, weekend users, California users, etc.). Such attribution is effectively a measure of the influence attributed to a given touchpoint, touchpoint attribute, and/or group of touchpoints in transitioning the segment of users from one engagement state to another engagement state (see FIG. 2C). In some cases, the segment might represent a given marketing channel (e.g., display, search, TV, etc.) and/or device platform (e.g., mobile, desktop, etc.).

Further, a marketing manager (e.g., manager 104₁) can use the touchpoint attributions 266 to further allocate spend among the various touchpoints by selecting associated touchpoint spend allocation values (see step 254). For example, the manager 104₁ might apply an overall marketing budget (e.g., in USS) for digital media channels to the various intra-channel touchpoints. In some cases, the manager 104₁ can allocate the budget according to the relative touchpoint contributions presented in the touchpoint attributions 266 to produce certain instances of touchpoint spend allocations 268 as shown. In other cases, the touchpoint spend allocations 268 can be automatically generated based on the touchpoint attributions 266. Such touchpoint spend allocations 268 might be used to determine certain instances of allocated media buy parameters (e.g., total spend, auction bid maximum, etc.) that can be used by various programmatic media buying execution platforms when executing a media plan (see step 256).

In one or more embodiments, the input parameter generation technique 2A00 and/or other herein disclosed techniques can be applied at various measurement levels. For example, the herein disclosed techniques can be applied at an enterprise level, a campaign level, a channel level, a user level, a touchpoint level, a touchpoint attribution level, a placement level, a keyword level, and/or other levels and/or any combination of levels. One embodiments of a data structure to facilitate such measurement levels is described in FIG. 3B.

FIG. 3B presents a touchpoint attribute chart 2B00 showing sample attributes associated with touchpoints of a media campaign. As an option, one or more instances of touchpoint attribute chart 2B00 or any aspect thereof may be implemented in the context of the architecture and functionality of the embodiments described herein. Also, the touchpoint attribute chart 2B00 or any aspect thereof may be implemented in any desired environment.

As discussed herein, a touchpoint (e.g., touchpoints 157) can be any occurrence where a user interacts with any aspect of a media campaign (e.g., display ad, keyword search, TV ad, etc.). Recording stimulation through media placement (e.g., placement of a message or placement of an online advertisement, or a banner ad, or a television spot, or a radio spot, or a direct mailer event, etc.) and respective response touchpoints associated with a marketing campaign can enable certain key performance indicators (KPIs) for the campaign to be determined at various measurement levels. For example, touchpoint information (e.g., touchpoint attribute records 177) might be captured in the stimulus data records 172, the response data records 174, and/or other data records for use by the herein disclosed techniques. Yet, some touchpoints are more readily observed than other touchpoints. Specifically, touchpoints in non-digital media channels might be not be observable at a user level and/or an individual transaction level, such that summary and/or aggregate responses in non-digital channels are provided. In comparison, touchpoints in digital media channels can be captured real-time at a user level (e.g., using Internet technology). The attributes of such touchpoints in digital media channels can be structured as depicted in the touchpoint attribute chart 2B00.

Specifically, the touchpoint attribute chart 2B00 shows a plurality of touchpoints (e.g., touchpoint T4 204₁, touchpoint T6 206₁, touchpoint T7 207₁, touchpoint T8 208₁, touchpoint T5 205₁, and touchpoint T9 209₁) that might be collected and stored (e.g., in response data store 236) for various analyses (e.g., at measurement server 110, apportionment server 111, etc.). The example dataset of touchpoint attribute chart 2B00 maps the various touchpoints with a plurality of attributes 232 associated with respective touchpoints. For example, the attribute “Channel” identifies the type of channel (e.g., “Display”, “Search”) that delivers the touchpoint, the attribute “Message” identifies the type of message (e.g., “Brand”, “Call to Action”) delivered in the touchpoint, and so on. More specifically, as indicated by the “Event” attribute, touchpoint T4 204₁ was an “Impression” presented to the user, while touchpoint T6 206₁ corresponds to an item (e.g., “Call to Action” for “Digital SLR”) the user responded to with a “Click”. Also, as represented by the “Indicator” attribute, touchpoint T14 204₁ was presented (e.g., as indicated by a “1”) in the time window specified by the “Recency” attribute (e.g., “30+Days”), while touchpoint T9 209₁ was not presented (e.g., as indicated by a “0”) in the time window specified by the “Recency” attribute (e.g., “<2 hours”). For example, the “Indicator” can be used to distinguish the touchpoints actually exposed to a user (e.g., comprising the stimulus data records 172) as compared to planned touchpoint stimulus. In some cases, the “Indicator” can be used to identify responses to a given touchpoint (e.g., a “1” indicates the user responded with a click, download, etc.).

Further, as indicated by the “User” attribute, touchpoint T4 204₁ was presented to a user identified as “UUID123”, while touchpoint T6 206₁ was presented to a user identified as “UUID456”. A “Tracking ID” attribute might also be associated with a given touchpoint attribute record to facilitate tracking of the touchpoint and/or touchpoint attributes among various entities in the advertising ecosystem. For example, the touchpoint T4 204₁ might have the tracking ID “T4_567” to indicate that this instance of touchpoint T4 is associated with one or more entities identified by the suffix “_567”. Specifically, the tracking ID might carry information about a media plan execution partner (e.g., a DSP) and/or the partner's client (e.g., an advertiser). The remaining information in the touchpoint attribute chart 2B00 identifies other attribute values for the plurality of touchpoints.

A measurable relationship between one or more touchpoints and a progression through engagement and/or readiness states towards a target state is possible. In some cases, the relationship between touchpoints is deterministic (e.g., based on UUID, tracking ID, etc.). In other cases, the relationship between touchpoints can be probabilistic (e.g., a likelihood that two or more touchpoints are related). Such a collection of touchpoints contributing to reaching the target state (e.g., conversion, brand engagement, etc.) can be called an engagement stack. Indeed, such engagements stacks can be applied to a stimulus attribution predictive model (e.g., stimulus attribution predictive model 162) to determine the attribution (e.g., contribution values) of each touchpoint (e.g., touchpoint attributions 266) associated with certain desired responses, such as conversion events, brand engagement events, and/or other events. When analyzing the impact of touchpoints on a user's engagement progression and possible execution of the target response event, a time-based progression view of the touchpoints and a contribution value of the touchpoints (e.g., touchpoint attribution) can be considered as shown in FIG. 3C.

FIG. 3C illustrates a touchpoint attribution technique 2C00. As an option, one or more instances of touchpoint attribution technique 2C00 or any aspect thereof may be implemented in the context of the architecture and functionality of the embodiments described herein. Also, the touchpoint attribution technique 2C00 or any aspect thereof may be implemented in any desired environment.

The touchpoint attribution technique 2C00 illustrates an engagement stack progression 201 that is transformed by the stimulus attribution predictive model 162 to a touchpoint attribution chart 211. Specifically, the engagement stack progression 201 depicts a progression of touchpoints experienced by one or more users. More specifically, a User1 engagement progress 202 and a UserN engagement progress 203 are shown as representative of a given audience (e.g., comprising User1 to UserN) The User1 engagement progress 202 and the UserN engagement progress 203 represent the user's progress from a state x₀ 220₁ to a state xₙ₊₁ 222₁ over a time τ₀ 224 to a time t 226. For example, the state x₀ 220₁ can represent an initial user engagement state (e.g., no engagement) and the state xₙ₊₁ 222₁ can represent a final user engagement state (e.g., conversion, brand engagement event, etc.). Further, the time τ₀ 224 to the time t 226 can represent a measurement time window for performing touchpoint attribution analyses. As shown in User1 engagement progress 202, User1 might experience a touchpoint T4 204₂ comprising a branding display creative published by Yahoo!. At some later moment, User1 might experience a touchpoint T6 206₂ comprising Google search results (e.g., search keyword “Digital SLR”) prompting a call to action. At yet another moment later in time, User1 might experience a touchpoint T7 207₂ comprising Google search results (e.g., search keyword “Best Rated Digital Camera”) also prompting a call to action. Also as shown in UserN engagement progress 203, UserN might experience a touchpoint T4 204₃ having the same attributes as touchpoint T4 204₂. At some later moment, UserN might experience a touchpoint T7 207₃ having the same attributes as touchpoint T7 207₂. At yet another moment later in time, UserN might experience a touchpoint T8 208₂ comprising a call-to-action display creative published by DataXu. Any number of timestamped occurrences of these touchpoints and/or additional information pertaining to the touchpoints and/or user responses to the touchpoints (e.g., captured in attributes 232), can be received over the network in real time for use in generating the stimulus attribution predictive model 162 and/or generating the touchpoint attribution chart 211.

Specifically, the touchpoint attribution chart 211 shows the touchpoint contribution values (e.g., touchpoint contribution value 214, touchpoint contribution value 216, touchpoint contribution value 217, and touchpoint contribution value 218) of all instances of the respective touchpoints (e.g., touchpoint T4, touchpoint T6, touchpoint T7, and touchpoint T8, respectively) aggregated over a segment 212. In some cases, the segment 212 might comprise a certain group of users (e.g., an audience of N users, all male users age 18-25, etc.). In other cases, the segment 212 might be associated with a certain media channel (e.g., display, search, radio, print, email, etc.) and/or delivery platform (e.g., desktop, mobile, etc.). The overall contribution value of the touchpoints pertaining to the segment 212 is defined by a total contribution value 210. Various techniques (e.g., the input parameter generation technique 2A00) can determine the contribution value from the available touchpoint data (e.g., stimulus data records 172, response data records 174, etc.). As shown, the contribution values indicate a measure of the influence (e.g., lift, contribution, conversion credit, etc.) attributed to a respective touchpoint in transitioning a user in the segment 212 from state x₀ 220₂ to state xₙ₊₁ 222₂.

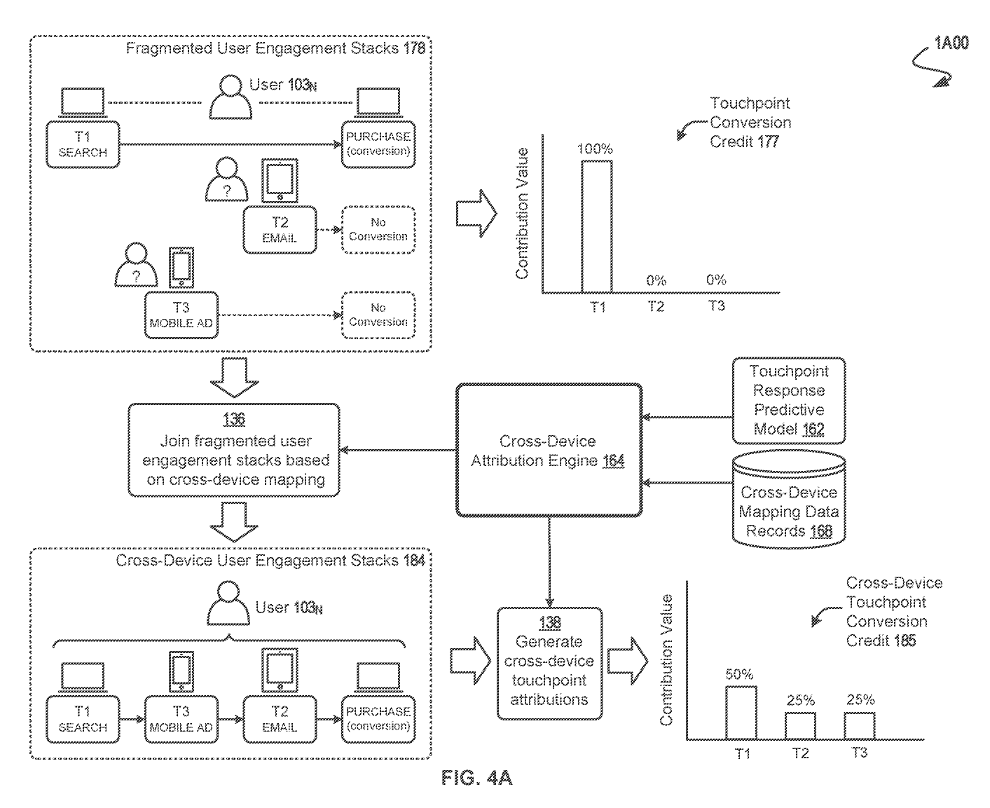

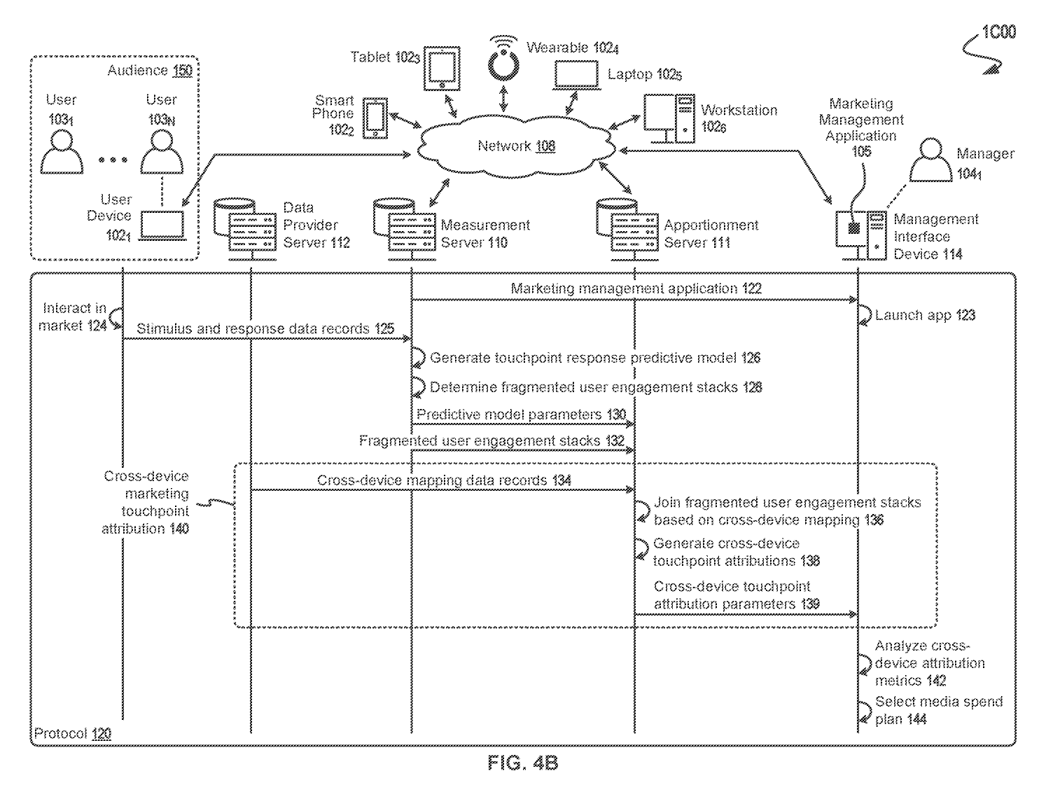

FIG. 4A illustrates a scenario 1A00 for cross-device marketing touchpoint attribution. As an option, one or more instances of scenario 1A00 or any aspect thereof may be implemented in the context of the architecture and functionality of the embodiments described herein. Also, the scenario 1A00 or any aspect thereof may be implemented in any desired environment.

As shown in the scenario 1A00, various touchpoints (e.g., including marketing messages, banner advertisements, emails, surveys, etc.) exposed on multiple devices can comprise a set of fragmented user engagement stacks 178. Such touchpoints can be “fragmented” when associations (e.g., mapping) between users and the one or more devices used by a respective user are not established across all such devices. Specifically, a user 103_{N} might be determined to be associated with a certain laptop computer device using browser cookie data captured when the user 103_{N} is logged into various online accounts. For example, when the user 103_{N} searches for clothing on the laptop and clicks on the paid search ad for Brand X (e.g., touchpoint T1), the touchpoint response data can associate touchpoint T1 to user 103_{N} using a universally unique identifier (UUID), such as a user ID. The touchpoint response data can further indicate that the user 103_{N} made a Brand X purchase (e.g., conversion) on the laptop at a later time. In some cases, the user 103_{N} might further use other devices (e.g., mobile phone, tablet, etc.) yet not be associated with such devices by the foregoing UUID. Specifically, activity on mobile devices can be associated with a device identifier (DID) and/or mobile identification number (MIN). For example, prior to conversion on the laptop, the user 103_{N} might have seen and been influenced by an ad from Brand X on a mobile phone (e.g., touchpoint T3), and by a promotional email from Brand X on a tablet (e.g., touchpoint T2), yet such touchpoints might appear fragmented from touchpoint T1 and each other in the touchpoint response data. Such fragmentation can result in a touchpoint conversion credit 177 that attributes all the credit for the conversion to touchpoint T1, and no credit for the conversion to touchpoint T2 or touchpoint T3.

The herein disclosed techniques can address such problems with associating the fragmented cross-device touchpoints of each user when generating touchpoint attribution. Specifically, a cross-device attribution engine 164 can use certain instances of cross-device mapping data records 168 to join the fragmented user engagement stacks 178 to produce a set of cross-device user engagement stacks 184 (see operation 136). The cross-device attribution engine 164 can further apply the cross-device user engagement stacks 184 to a touchpoint response predictive model 162 to generate cross-device touchpoint attributions (see operation 138). Specifically, for example, the cross-device user engagement stacks 184 can comprise an engagement stack for user 103_{N} that links the touchpoints (e.g., T1, T3, and T2) experienced across all the devices (e.g., laptop, mobile phone, and tablet, respectively) used by the user 103_{N}. When the cross-device user engagement stacks 184 are applied to the touchpoint response predictive model 162, a chart of the cross-device touchpoint conversion credit 185 is produced. As shown, touchpoint T1 might now receive 50% of the conversion credit, and touchpoint T2 and touchpoint T3 might now each receive 25% of the conversion credit.

The cross-device touchpoint conversion credit 185 provided by the herein disclosed techniques can show a more complete and/or accurate view of media impact across multiple devices. Specifically, the marketing manager might use the results produced by the herein disclosed techniques to better understand the true (e.g., more accurate) effectiveness and/or return on investment (ROI) of campaigns associated with certain device types and/or channels to enable more effective cross-device and/or cross-channel media spend allocations. Such techniques disclosed herein for cross-device marketing touchpoint attribution are described in more detail in the following.

FIG. 4B shows an environment 1C00 in which embodiments of the present disclosure can operate. As shown in FIG. 4B, the environment 1C00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1C00 comprises at least one instance of a measurement server 110, at least one instance of an apportionment server 111, at least one instance of data provider server 112, and at least one instance of the management interface device 114. The servers and devices shown in environment 1C00 can represent any single computing system with dedicated hardware and software, multiple computing systems clustered together (e.g., a server farm, a host farm, etc.), a portion of shared resources on one or more computing systems (e.g., a virtual server), or any combination thereof. In one or more embodiments, the data provider server 112 can represent an entity (e.g., cross-device data provider) in an online advertising ecosystem that might aggregate certain online activity data (e.g., login information, connection IP addresses, Wi-Fi networks used, websites visited, etc.) for the purposes of determining the devices operated by the same user. Such cross-device mapping can produce cross-device mapping data (e.g., cross-device mapping data records 168) using various methods, such as deterministic matching, probabilistic matching, and/or other methods. In some cases the cross-device mapping is based on a shared characteristic between two more user devices (e.g., login information in common, one or more shared IP addresses, one or more shared Wi-Fi networks used, similar websites visited, etc.).

The environment 1C00 further comprises at least one instance of a user device 102₁ that can represent one of a variety of other computing devices (e.g., user devices 102, a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102₁ can be operated by a user 103_{N}. Other users (e.g., user 103₁) with or without a corresponding user device can comprise the audience 150.

As shown, the user 103₁, the user device 102₁ (e.g., operated by user 103_{N}), the measurement server 110, the apportionment server 111, the data provider server 112, and the management interface device 114 (e.g., operated by the manager 104₁) can exhibit a set of high-level interactions (e.g., operations, messages, etc.) in a protocol 120. Specifically, the protocol can represent interactions in systems for cross-device marketing touchpoint attribution. As shown, the manager 104₁ can download the marketing management application 105 from the measurement server 110 to the management interface device 114 (see message 122) and launch the application (see operation 123). Users in audience 150 can also interact with various marketing campaign stimuli delivered through certain media channels (see operation 124), such as taking one or more measurable actions in response to such stimuli and/or other non-media effects. Information characterizing the stimuli and responses of the audience 150 can be collected as stimulus data records (e.g., stimulus data records 172) and response data records (e.g., response data records 174) by the measurement server 110 (see message 125). Using the stimulus and response data, the measurement server 110 can generate a stimulus attribution predictive model (see operation 126), such as touchpoint response predictive model 162. The measurement server 110 can further use the stimulus and response data to determine a set of fragmented user engagement stacks (see operation 128). For example, the fragmented user engagement stacks can be generated by linking touchpoints known to be associated with a given user based on the information (e.g., fragmented cross-device touchpoints) provided in the stimulus and response data. The model parameters characterizing the aforementioned generated predictive model can be availed to the apportionment server 111 (see message 130). The information representing the fragmented user engagement stacks can further be provided to the apportionment server 111 (see message 132).

As highlighted in the protocol 120, a grouping 140 can represent one embodiment of certain messages and operations used in systems and protocols for cross-device marketing touchpoint attribution. Specifically, such a grouping of interactions might commence with certain cross-device mapping data records received by the apportionment server 111 from the data provider server 112 (see message 134). The apportionment server 111 can use the cross-device mapping data to join the fragmented user engagement stacks (see operation 136). The joined cross-device engagement stacks can be applied to the touchpoint response predictive model to generate cross-device touchpoint attributions (see operation 138). The cross-device touchpoint attribution parameters characterizing the cross-device touchpoint attributions can then be availed to the management interface device 114 (see message 139). As earlier mentioned, the manager 104₁ can analyze the cross-device touchpoint attribution performance metrics (see operation 142) to select a media spend plan for deployment to the audience 150 (see operation 144).

As shown in FIG. 4B, the techniques disclosed herein address the problems attendant to associating the fragmented cross-device touchpoints of each user when generating touchpoint attribution, in part, by applying a set of cross-device touchpoint engagement stacks to a touchpoint response predictive model (e.g., touchpoint response predictive model 162). More details pertaining such touchpoint response predictive models are discussed in the following and herein.

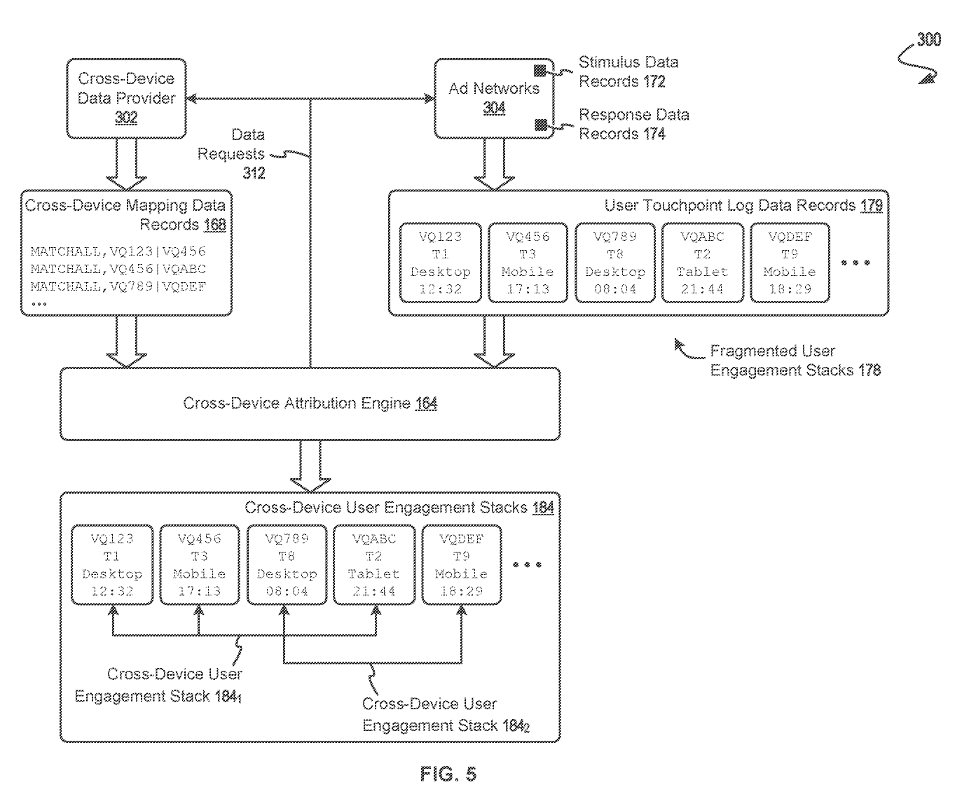

FIG. 5 presents a cross-device engagement stack joining technique 300 used in systems for cross-device marketing touchpoint attribution. As an option, one or more instances of cross-device engagement stack joining technique 300 or any aspect thereof may be implemented in the context of the architecture and functionality of the embodiments described herein. Also, the cross-device engagement stack joining technique 300 or any aspect thereof may be implemented in any desired environment.

The embodiment shown in FIG. 5 depicts the cross-device engagement stack joining technique 300 implemented by the cross-device attribution engine 164 to generate the cross-device user engagement stacks 184 for cross-device marketing touchpoint attribution. Specifically, the cross-device attribution engine 164 can use a set of cross-device mapping data records 168 and/or a set of fragmented user engagement stacks 178 to generate the cross-device user engagement stacks 184. More specifically, the cross-device mapping data records 168 might be received by the cross-device attribution engine 164 from a cross-device data provider 302. Further, the fragmented user engagement stacks 178 might be derived from a set of user touchpoint log data records 179 received from one or more ad networks 304. For example, the user touchpoint log data records 179 might be included in the stimulus data records 172 and/or the response data records 174 further provided by the ad networks 304. In some cases, the cross-device data provider 302 and/or the ad networks 304 can be polled continuously and/or at various times using instances of data requests 312 (e.g., HTTP requests) to collect the most relevant (e.g., most recent) set of data records for use in generating the cross-device user engagement stacks 184.

As shown, the structure and information in the cross-device mapping data records 168 can indicate the identifiers (e.g., VQ123, VQ456, etc.) that have been determined, in part, by various cross-device mapping techniques, to be associated with the same user. In one or more embodiments, such identifiers can be created for the purposes of cross-device mapping such that no personally identifiable information (PII) and/or only non-personally identifiable information (NPII) is transferred to the cross-device attribution engine 164. For example, the line “MATCHALL,VQ123|VQ456” in the cross-device mapping data records 168 can indicate that a user identifier VQ123 associated with a first user device has been determined to be mapped to a user identifier VQ456 associated with a second user device. Likewise, the cross-device mapping data records 168 indicates a user identifier VQ456 is mapped to a user identifier VQABC, and a user identifier VQ789 is mapped to a user identifier VQDEF. By the associative property, the user identifier VQ123 is also mapped to the user identifier VQABC.

As further shown in FIG. 5, the structure and information in the user touchpoint log data records 179 can indicate certain information pertaining a touchpoint exposure event for a given user. For illustrative purposes, representative attributes characterizing the touchpoint exposure event are shown. Specifically, each instance of the user touchpoint log data records 179 comprises an identifier, a touchpoint identifier, a device identifier, and an event timestamp. In one or more embodiments, the user identifiers in the user touchpoint log data records 179 can correspond to the identifiers used in the cross-device mapping data records 168 to facilitate implementation of the herein disclosed techniques.

For example, a user represented by the identifier VQ123 was exposed to touchpoint T1 on a Desktop computer at time 12:23. As another example, a user represented by the identifier VQABC was exposed to touchpoint T9 on a Mobile device at time 18:29. As shown, none of the identifiers in the user touchpoint log data records 179 are matching, yet some logs might be associated with a single user. In such cases, the user touchpoint log data records 179 can comprise fragmented cross-device touchpoints and/or fragmented user engagement stacks 178.

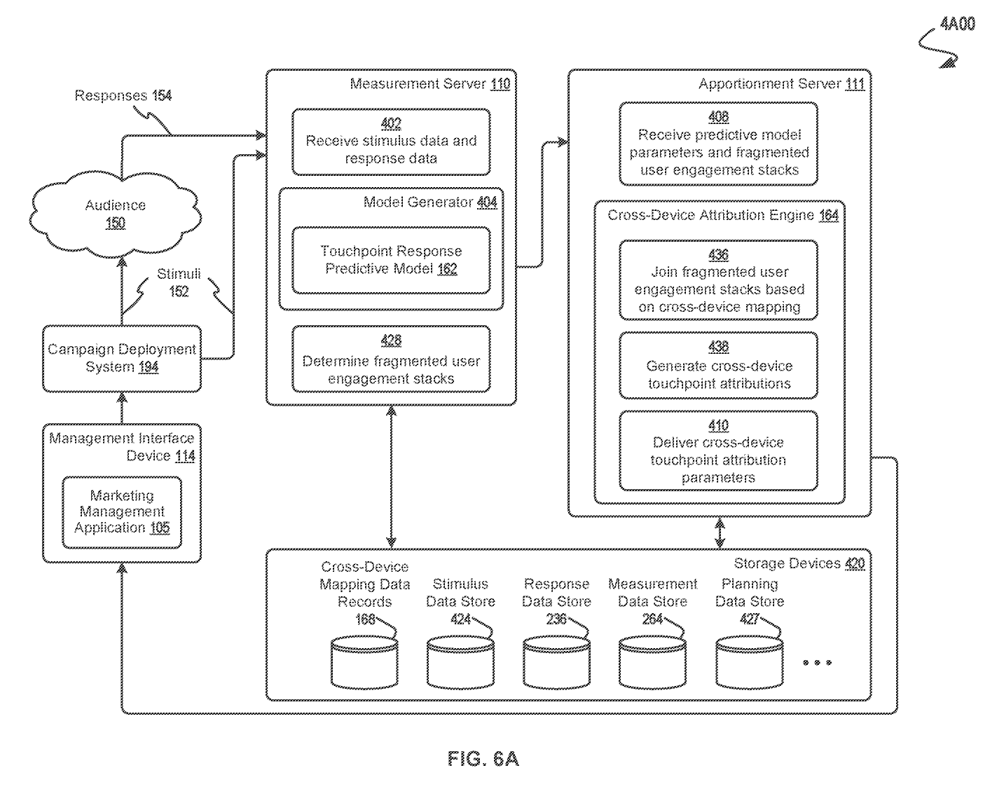

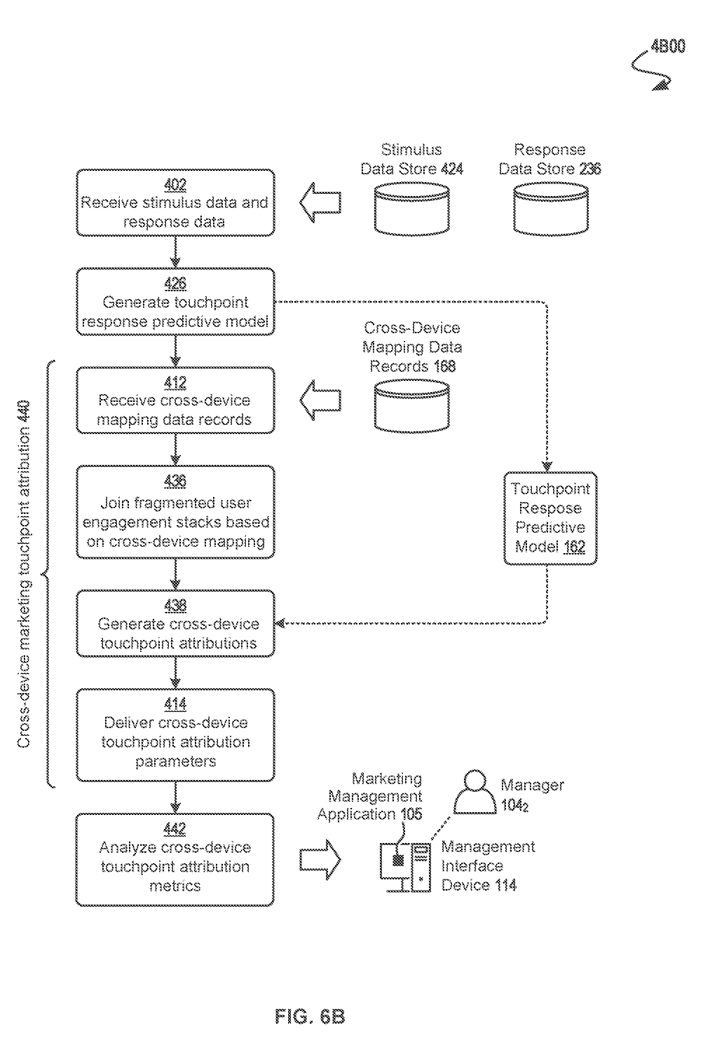

The cross-device engagement stack joining technique 300 and/or other techniques disclosed herein can address such problems pertaining to associating the fragmented cross-device touchpoints and/or fragmented user engagement stacks 178. Specifically, the cross-device attribution engine 164 can apply the cross-device mapping data records 168 to the user touchpoint log data records 179 to determine one or more instances of cross-device user engagement stacks 184. For example, as shown, the logs for identifiers VQ123, VQ456, and VQAC are mapped together in a cross-device user engagement stack 184₁, and the logs for identifiers VQ789 and VQDEF are mapped together in a cross-device user engagement stack 184₂. Such instances of cross-device user engagement stacks 184 can then be used by the cross-device attribution engine 164 and/or other components of systems implementing the herein disclosed techniques to provide cross-device marketing touchpoint attribution. One embodiment of such systems is discussed as pertains to FIG. 6A.

FIG. 6A depicts a subsystem 4A00 for cross-device marketing touchpoint attribution. As an option, one or more instances of subsystem 4A00 or any aspect thereof may be implemented in the context of the architecture and functionality of the embodiments described herein. Also, the subsystem 4A00 or any aspect thereof may be implemented in any desired environment.

As shown, subsystem 4A00 comprises certain components earlier described in FIG. 4A and/or FIG. 4C. Specifically, the campaign deployment system 194 can present the stimuli 152 to the audience 150 to produce the responses 154. The measurement server 110 can receive electronic data records associated with the stimuli 152 and responses 154 (see operation 402). The stimulus data and response data can be stored in one or more storage devices 420 (e.g., stimulus data store 424, response data store 236, etc.). The measurement server 110 further comprises a model generator 404 that can use the stimulus data, response data, and/or other data to generate the touchpoint response predictive model 162. In some embodiments, the model parameters (e.g., touchpoint response predictive model parameters 176) characterizing the touchpoint response predictive model 162 can be stored in the measurement data store 264. The measurement server 110 can further determine one or more user engagement stacks based on the fragmented cross-device touchpoint information included in the stimulus data and/or response data (see operation 428).

As shown, the apportionment server 111 can receive the predictive model parameters and information describing the fragmented user engagement stacks from the measurement server 110 (see operation 408). An instance of the cross-device attribution engine 164 operating on the apportionment server 111 can join the fragmented user engagement stacks based on cross-device mapping (e.g., from cross-device mapping data records 168) to form a set of cross-device user engagement stacks (see operation 436). Such cross-device user engagement stacks can be used by the cross-device attribution engine 164 to generate cross-device touchpoint attributions (see operation 438). Cross-device touchpoint attribution parameters characterizing the cross-device touchpoint attributions can be delivered (see operation 410) to the marketing management application 105 operating on the management interface device 114 to facilitate the development of media spend plans. In one or more embodiments, the data representing such media spend plans can be stored in a planning data store 427.

The subsystem 4A00 presents merely one partitioning. The specific example shown where the measurement server 110 comprises the model generator 404, and where the apportionment server 111 comprises the cross-device attribution engine 164 is purely exemplary, and other partitioning is reasonable, and the partitioning may be defined in part by the volume of empirical data. In some cases, a database engine can serve to perform calculations (e.g., within, or in conjunction with a database engine query). A technique for cross-device marketing touchpoint attribution implemented in such systems, subsystems, and partitionings is shown in FIG. 6B.

FIG. 6B presents a flow chart 4B00 for cross-device marketing touchpoint attribution. As an option, one or more instances of flow chart 4B00 or any aspect thereof may be implemented in the context of the architecture and functionality of the embodiments described herein. Also, the flow chart 4B00 or any aspect thereof may be implemented in any desired environment.

The flow chart 4B00 presents one embodiment of certain steps for cross-device marketing touchpoint attribution. In one or more embodiments, the steps and underlying operations shown in the flow chart 4B00 can be executed by the measurement server 110 and apportionment server 111 disclosed herein. As shown, the flow chart 4B00 can commence with receiving stimulus data and response data from various sources (see operation 402), such as the stimulus data store 424 and/or the response data store 236. Using the aforementioned received data and/or other data, stimulus attribution predictive model such as the touchpoint response predictive model 162 can be generated (see operation 426).

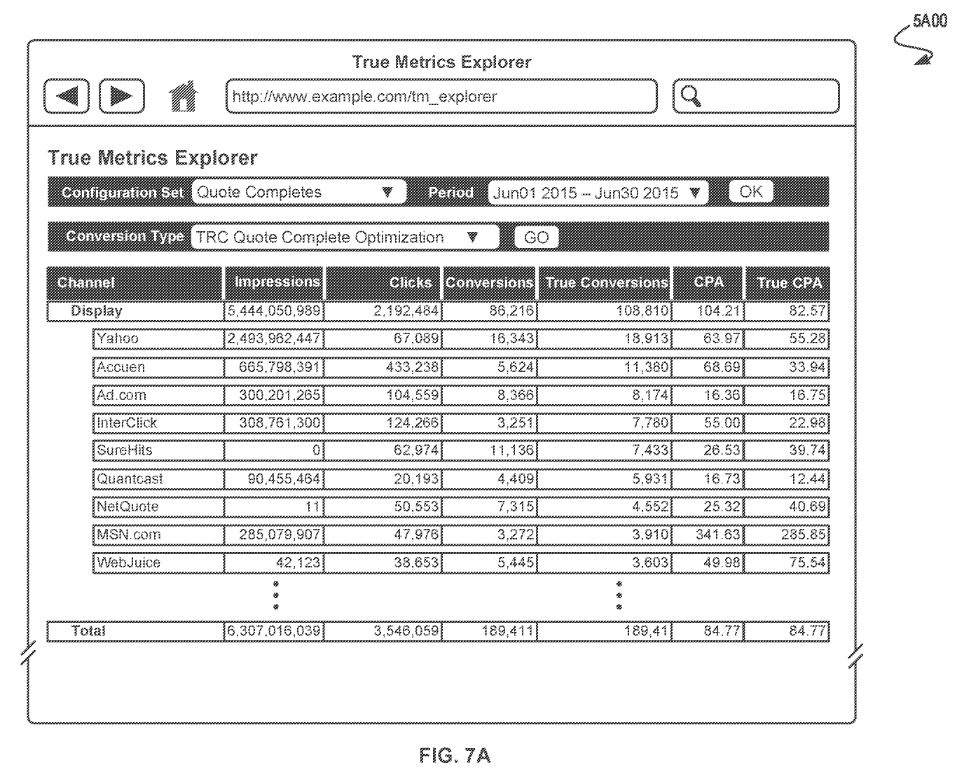

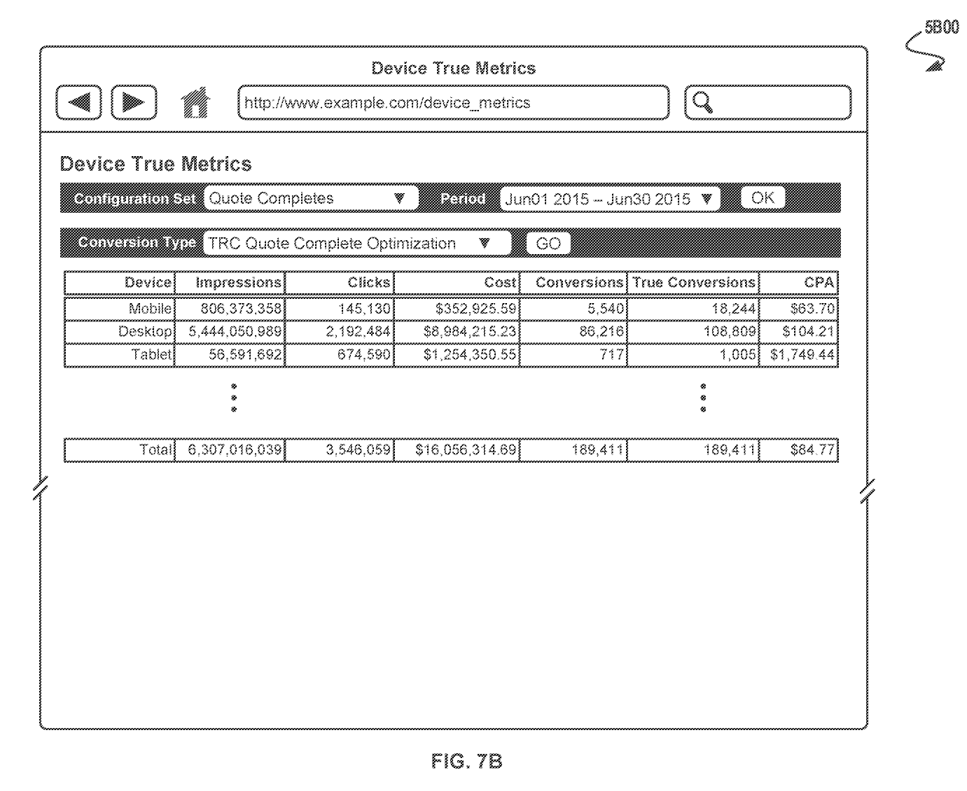

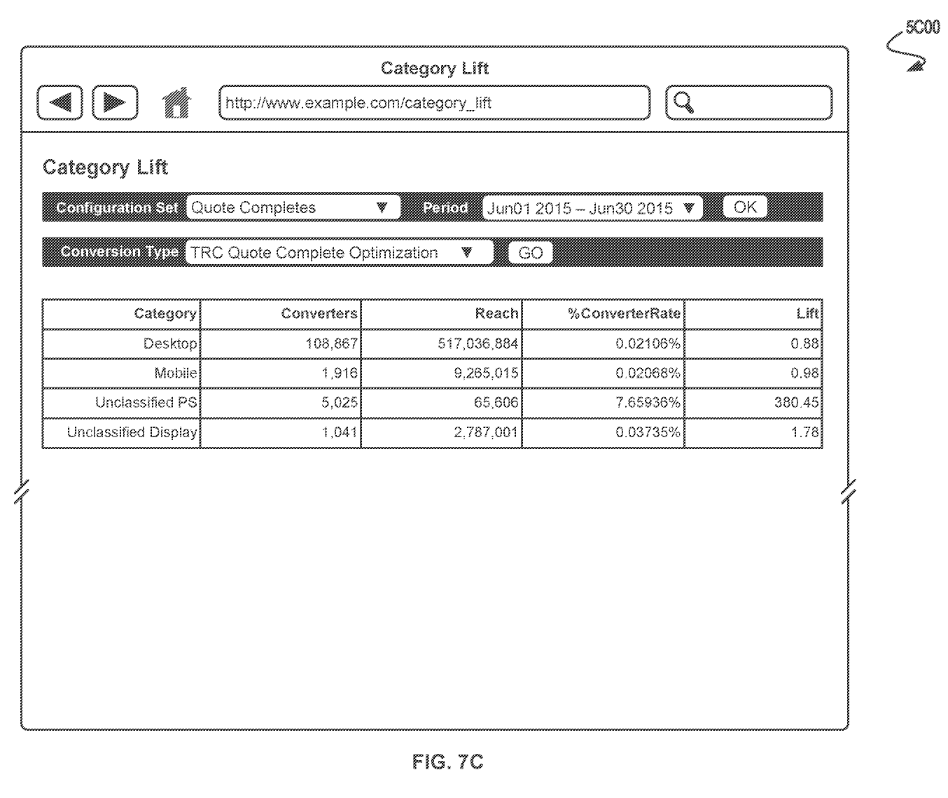

The flow chart 4B00 can continue with a set of steps and/or operations for cross-device marketing touchpoint attribution (see grouping 440). Specifically, a set of cross-device mapping data records (e.g., cross-device mapping data records 168) can be received (see step 412). A set of fragmented user engagement stacks can then be joined using the cross-device mapping data records (see operation 436). The resulting cross-device user engagement stacks can be applied to the touchpoint response predictive model to generate cross-device touchpoint attributions (see operation 438). Cross-device touchpoint attribution parameters characterizing the cross-device touchpoint attributions can be delivered (see operation 414) to facilitate the analysis of certain cross-device touchpoint attribution metrics (see operation 442). For example, the marketing manager 104₂ might interface with the marketing management application 105 on the management interface device 114 to analyze such metrics. In one or more embodiments, a portion of such application interfaces can be represented as shown in FIG. 7A, FIG. 7B, and FIG. 7C.

FIG. 7A presents a channel attribution metrics interface 5A00 used in systems for cross-device marketing touchpoint attribution. As an option, one or more instances of channel attribution metrics interface 5A00 or any aspect thereof may be implemented in the context of the architecture and functionality of the embodiments described herein. Also, the channel attribution metrics interface 5A00 or any aspect thereof may be implemented in any desired environment.

In one or more embodiments, the channel attribution metrics interface 5A00 can enable a user (e.g., a marketing manager) to analyze digital channel performance metrics that are derived from cross-device marketing touchpoint attribution. For example, as shown, for a given time period, the user can view certain performance metrics (e.g., impressions, clicks, conversions, true conversions, CPA, true CPA, etc.) associated with various publishers in the online display channel. Specifically, using the herein disclosed techniques, true conversions and true CPA can account for all media across all devices.

FIG. 7B presents a device attribution metrics interface 5B00 used in systems for cross-device marketing touchpoint attribution. As an option, one or more instances of device attribution metrics interface 5B00 or any aspect thereof may be implemented in the context of the architecture and functionality of the embodiments described herein. Also, the device attribution metrics interface 5B00 or any aspect thereof may be implemented in any desired environment.

In one or more embodiments, the device attribution metrics interface 5B00 can enable a user (e.g., a marketing manager) to analyze device platform performance metrics derived from cross-device marketing touchpoint attribution. For example, as shown, certain performance metrics (e.g., impressions, clicks, cost, conversions, true conversions, CPA, etc.) can be viewed for a given device type, such as mobile, desktop, tablet, and/or other device types. In accordance with the scenario 1A00 earlier described, true conversions for mobile (e.g., 18,224.58) and tablet (e.g., 1.005.68) using the herein disclosed techniques might increase (e.g., as compared to conversions of 5,540.00 and 717.00, respectively) as conversion credit is transferred from desktop, brand equity, and/or another category.

FIG. 7C presents a category lift metrics interface 5C00 used in systems for cross-device marketing touchpoint attribution. As an option, one or more instances of category lift metrics interface 5C00 or any aspect thereof may be implemented in the context of the architecture and functionality of the embodiments described herein. Also, the category lift metrics interface 5C00 or any aspect thereof may be implemented in any desired environment.

In one or more embodiments, the category lift metrics interface 5C00 can enable a user (e.g., a marketing manager) to analyze category lift performance metrics derived from cross-device marketing touchpoint attribution. For example, as shown, certain performance metrics (e.g., converters, reach, converter rate, lift, etc.) can be viewed for a given media category (e.g., desktop, mobile, unclassified paid search (PS), unclassified display, etc.). For example, the category lift metrics interface 5C00 might present metrics that quantify the effectiveness of mobile in contributing to conversions on desktop. Further, as user engagement stacks are joined using the herein disclosed techniques, the estimated reach metric may decrease since multiple fragmented “users” might be combined into fewer unique users. Also, the herein disclosed techniques may result in an increase in the number of converters seeing media as converters previously attributed to brand equity might be determined to have been exposed to mobile touchpoints.

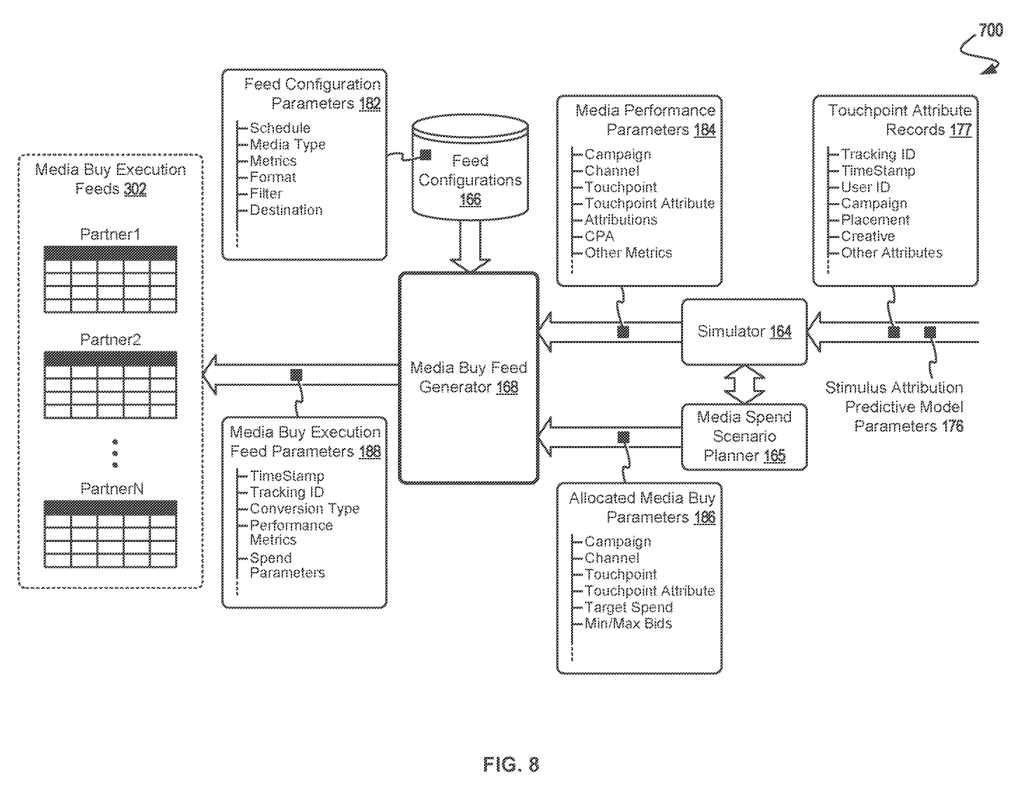

The touchpoint attribution technique 2C00 can be applied to generate attribution-informed media buy execution feeds for dynamic media buy optimization according to the herein disclosed techniques. One embodiment of a technique for generating the media buy execution feeds is described as pertains to FIG. 8.

FIG. 8 presents a media buy execution feed generation technique 700 used in systems for dynamic media buy optimization using attribution-informed media buy execution feeds. As an option, one or more instances of media buy execution feed generation technique 700 or any aspect thereof may be implemented in the context of the architecture and functionality of the embodiments described herein. Also, the media buy execution feed generation technique 700 or any aspect thereof may be implemented in any desired environment.

The embodiment shown in FIG. 8 depicts the media buy execution feed generation technique 700 implemented, in part, by the media buy feed generator 168 to facilitate dynamic media buy optimization using attribution-informed media buy execution feeds. Specifically, the simulator 164 can apply the touchpoint attribute records 177 received over a network to a stimulus attribution predictive model (e.g., the stimulus attribution predictive model 162) characterized by the stimulus attribution predictive model parameters 176 to determine the media performance parameters 184. Also, the media spend scenario planner 165 can use the stimulus attribution predictive model parameters 176 and/or the simulator 164 to determine certain instances of the allocated media buy parameters 186. Certain instances of feed configurations 166 comprising feed configuration parameters 182 can further be specified (e.g., by a marketing manager) and presented to the media buy feed generator 168. As shown, the media buy feed generator 168 can use the media performance parameters 184 and/or the allocated media buy parameters 186 and/or the feed configuration parameters 182 to generate one or more media buy execution feeds 302 comprising the media buy execution feed parameters 188. For example, the media buy execution feeds 302 might be configured (e.g., structured, scheduled, etc.) according to the feed configurations 166 for delivery to multiple data consumers (e.g., partner1, partner2, . . . , to partnerN).

The information associated with the touchpoint attribute records 177, the media performance parameters 184, the allocated media buy parameters 186, the feed configuration parameters 182, the media buy execution feed parameters 188, and/or other information used by the herein disclosed techniques can be related to various characteristics and/or be organized in various data structures. For example, each instance (e.g., log file entry, database table row entry, etc.) of the touchpoint attribute records 177 might comprise a tracking identifier, a timestamp, a user identifier, a campaign identifier, a placement identifier, a creative identifier, and/or other attributes (e.g., attributes 232). As another example, each instance of the media performance parameters 184 might comprise a campaign identifier, a channel identifier, a touchpoint identifier, a touchpoint attribute, an attribution metric (e.g., per touchpoint, per touchpoint attribute, etc.), a CPA metric, and/or other parameters. Further, for example, each instance of the allocated media buy parameters 186 might comprise a campaign identifier, a channel identifier, a touchpoint identifier, a touchpoint attribute, a target spend (e.g., per channel, per touchpoint, etc.), a minimum auction bid, a maximum auction bid, and/or other parameters. Also, for example, each instance of the feed configuration parameters 182 might characterize a schedule specification, a media type (e.g., placement, keyword, touchpoint, etc.), one or more metrics identifiers, a format specification, a filter, a destination, and/or other feed configuration attributes. As another example, each instance of the media buy execution feed parameters 188 might comprise a timestamp, a tracking identifier, a conversion type identifier, one or more performance metrics, one or more spend parameters, and/or other parameters. Moreover the format of media buy execution feed parameters 188 might conform, at least in part, to an output format specified as a “Marin Standard Feed”, or as a “Kenshoo Standard Feed”, or as a “Turn Placement Feed”, or as a “Touchpoint Feed”, or as a “Xasixs Placement Feed”, or as a “Ziff Davis feed”, or any combination of formats therefrom.

Instances of the media buy execution feed parameters 188 can be structured in the media buy execution feeds 302 to be dynamically delivered to multiple programmatic media buying execution platforms over a network responsive to the continuous stream of online stimulus and response data (e.g., comprising the touchpoint attribute records 177) received from the network. Embodiments of such feeds are described as pertains to FIG. 4A, FIG. 4B, and FIG. 4C.

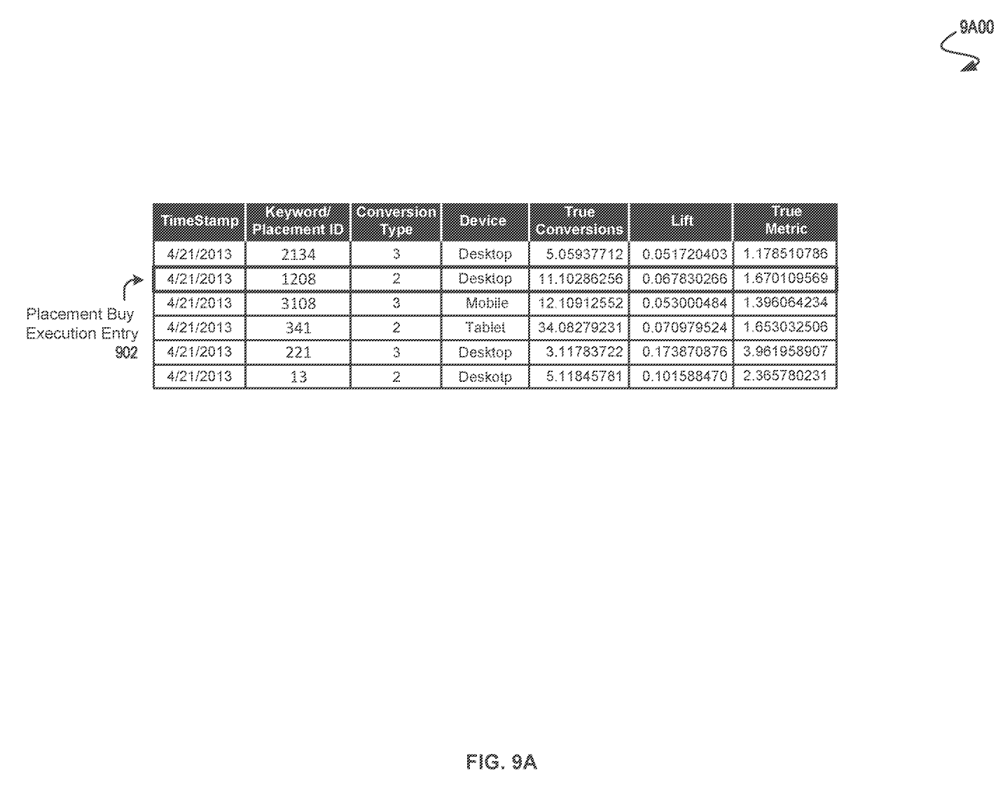

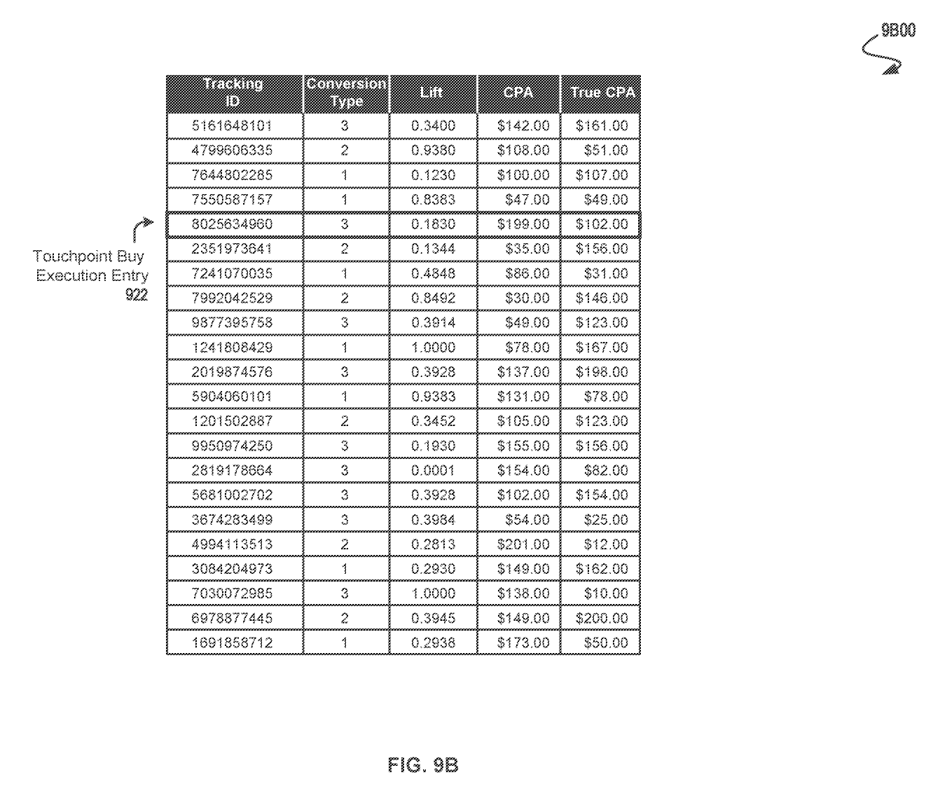

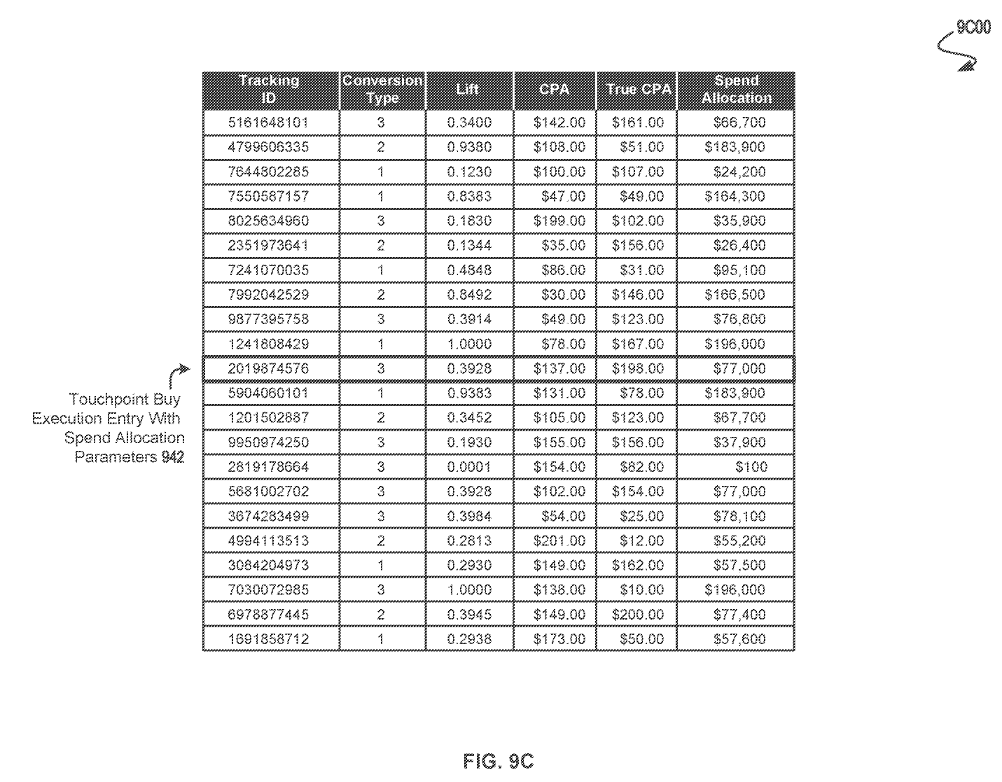

FIG. 9A depicts an attribution-informed placement feed data structure 9A00 used in systems for dynamic media buy optimization using attribution-informed media buy execution feeds. As an option, one or more instances of attribution-informed placement feed data structure 9A00 or any aspect thereof may be implemented in the context of the architecture and functionality of the embodiments described herein. Also, the attribution-informed placement feed data structure 9A00 or any aspect thereof may be implemented in any desired environment.

The embodiment shown in FIG. 9A is one example of a data structure for attribution-informed media buy execution feeds generated for dynamic media buy optimization according to the herein disclosed techniques. Specifically, the attribution-informed placement feed data structure 9A00 can represent the structure of a feed delivered to a programmatic media buying execution platform that includes fractional attribution metrics aggregated at a search keyword and/or advertising placement level. For example, the attribution-informed placement feed data structure 9A00 can be used to dynamically provide information to a DSP responsive to receiving the most recent audience behavior (e.g., stimulus data records 172 and/or response data records 174) from the Internet such that the DSP can optimally execute buys for certain keywords and/or placements. As shown, the attribution-informed placement feed data structure 9A00 can have a table structure comprising rows representing various keywords and/or placements, and columns representing certain attributes associated with each keyword and/or placement. For example, a placement buy execution entry 902 might correspond to a certain placement identified by a “Keyword/Placement ID” of “1208” associated with a “Conversion Type” of “2”, a “Desktop” device, a “True Conversions” metric of “11.10286256”, a “Lift” metric of “0.067830266”, and another “True Metric” of “1.670109569”. Variations of the attribution-informed placement feed data structure 9A00 are possible. For example, the attribution-informed placement feed data structure 9A00 can vary based on the requirements (e.g., feed configurations 166) of a respective programmatic media buying execution platform. Such platforms (e.g., DSPs) can further use the “Keyword/Placement ID” and/or other unique identifiers (e.g., ad server ID, etc.) to associate metrics and/or other parameters in the feed with various respective clients (e.g., advertisers).

FIG. 9B depicts an attribution-informed touchpoint feed data structure 9B00 used in systems for dynamic media buy optimization using attribution-informed media buy execution feeds. As an option, one or more instances of attribution-informed touchpoint feed data structure 9B00 or any aspect thereof may be implemented in the context of the architecture and functionality of the embodiments described herein. Also, the attribution-informed touchpoint feed data structure 9B00 or any aspect thereof may be implemented in any desired environment.

The embodiment shown in FIG. 4B is one example of a data structure for attribution-informed media buy execution feeds generated for dynamic media buy optimization according to the herein disclosed techniques. Specifically, the attribution-informed touchpoint feed data structure 9B00 can represent the structure of a feed delivered to a programmatic media buying execution platform that includes fractional attribution metrics aggregated at a touchpoint and/or impression level. For example, the attribution-informed touchpoint feed data structure 9B00 can be used to dynamically provide information to a DSP responsive to receiving the most recent audience behavior (e.g., stimulus data records 172 and/or response data records 174) from the Internet such that the DSP can optimally execute buys for touchpoints and/or impressions. As shown, the attribution-informed touchpoint feed data structure 4800 can have a table structure comprising rows representing various touchpoints and/or impressions, and columns representing certain attributes associated with each touchpoint and/or impression. For example, a touchpoint buy execution entry 922 might correspond to a certain touchpoint identified by a “Tracking ID” of “8025634960” associated with a “Conversion Type” of “3”, a “Lift” metric of “0.1830”, a “CPA” metric of “$199.00”, and a “True CPA” of “$102.00”. As earlier mentioned, the “Tracking ID” might be used to facilitate tracking of touchpoints and/or touchpoint attributes among various entities in the advertising ecosystem. In one or more embodiments, a tracking ID (e.g., foreign key ID, auction ID, etc.) might be inserted into a pixel tag at an ad server to be included in the touchpoint attributes associated with each impression and/or click and/or other event. Also, variations of the attribution-informed touchpoint feed data structure 4B00 are possible. For example, the attribution-informed touchpoint feed data structure 4B00 can vary based on the requirements (e.g., feed configurations 166) of a respective programmatic media buying execution platform. Such platforms (e.g., DSPs) can further use the “Tracking ID” and/or other unique identifiers to associate metrics and/or other parameters in the feed with various respective clients (e.g., advertisers).

FIG. 9C depicts an attribution-informed touchpoint spend feed data structure 9C00 used in systems for dynamic media buy optimization using attribution-informed media buy execution feeds. As an option, one or more instances of attribution-informed touchpoint spend feed data structure 9C00 or any aspect thereof may be implemented in the context of the architecture and functionality of the embodiments described herein. Also, the attribution-informed touchpoint spend feed data structure 9C00 or any aspect thereof may be implemented in any desired environment.

The embodiment shown in FIG. 9C is one example of a data structure for attribution-informed media buy execution feeds generated for dynamic media buy optimization according to the herein disclosed techniques. Specifically, the attribution-informed touchpoint spend feed data structure 9C00 can represent the structure of a feed delivered to a programmatic media buying execution platform that includes fractional attribution metrics and spend allocation parameters aggregated at a touchpoint and/or impression level. For example, the attribution-informed touchpoint spend feed data structure 9C00 can be used to dynamically provide information to a DSP responsive to receiving the most recent audience behavior (e.g., stimulus data records 172 and/or response data records 174) from the Internet such that the DSP can optimally execute buys for touchpoints and/or impressions. As shown, the attribution-informed touchpoint spend feed data structure 9C00 can have a table structure comprising rows representing various touchpoints and/or impressions, and columns representing certain attributes associated with each touchpoint and/or impression More specifically, the attribution-informed touchpoint spend feed data structure 9C00 can have rows comprising fractional (e.g., per touchpoint, per touchpoint attribute, etc.) attribution metrics and fractional spend allocation parameters. For example, a touchpoint buy execution entry with spend allocation parameters 942 might correspond to a certain touchpoint identified by a “Tracking ID” of “2019874576” associated with a “Spend Allocation” metric of “$77,000”. For example, the “Spend Allocation” metric might represent the maximum aggregate amount a DSP can spend on the purchase of instances of touchpoint “2019874576”. Variations of the attribution-informed touchpoint spend feed data structure 9C00 are possible.

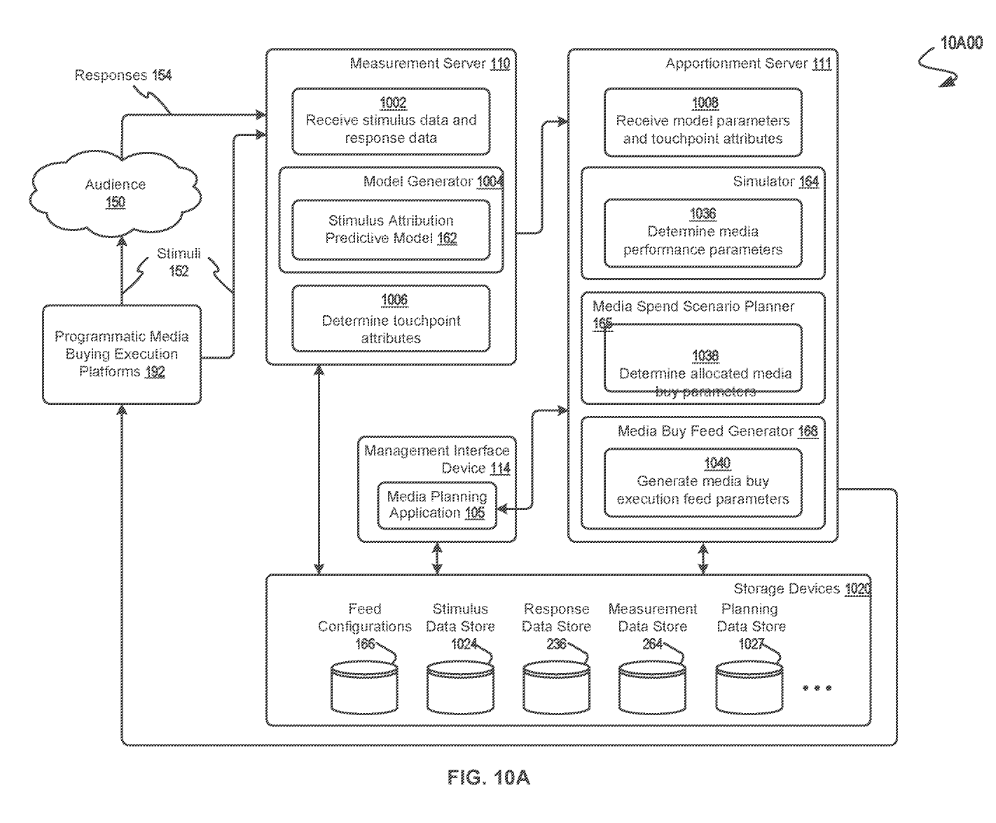

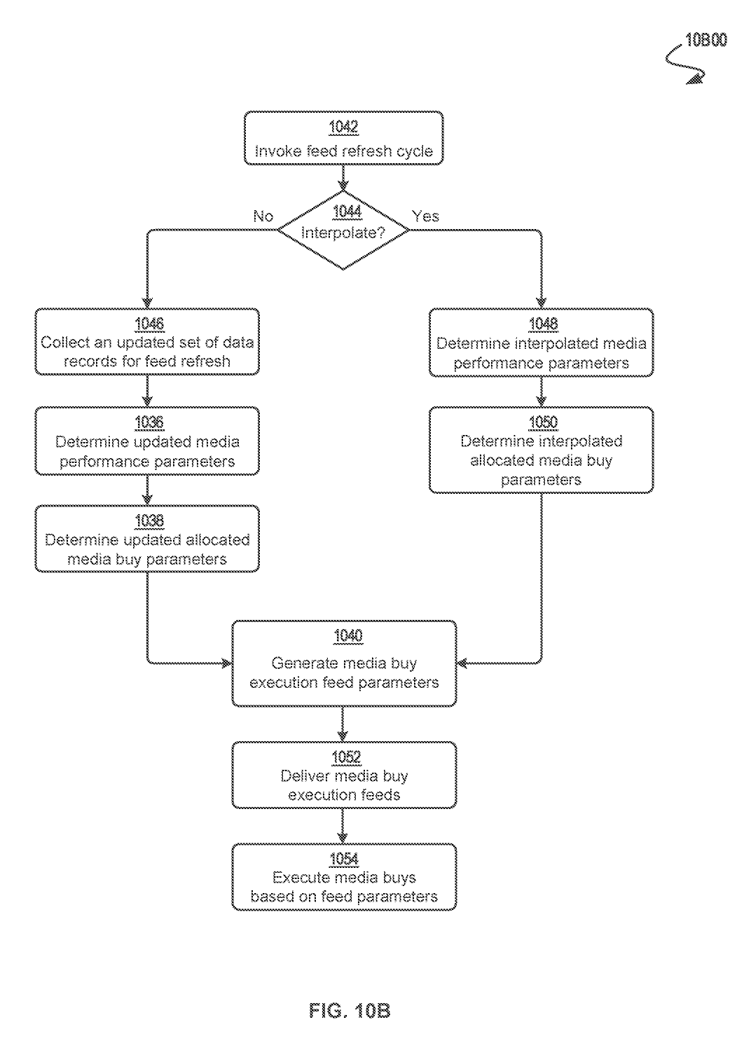

FIG. 10A depicts a subsystem 10A00 for dynamic media buy optimization using attribution-informed media buy execution feeds. As an option, one or more instances of subsystem 10A00 or any aspect thereof may be implemented in the context of the architecture and functionality of the embodiments described herein. Also, the subsystem 10A00 or any aspect thereof may be implemented in any desired environment.

As shown, subsystem 10A00 comprises certain components earlier described in FIG. 1A, and/or FIG. 1B. Specifically, the programmatic media buying execution platforms 192 can facilitate presenting a set of stimuli 152 to the audience 150 to produce the responses 154. For example, the set of stimuli 152 might correspond to various marketing campaigns associated with one or more advertising clients of the programmatic media buying execution platforms 192. As shown, the measurement server 110 can receive electronic data records associated with the stimuli 152 and responses 154 (see operation 1002). The stimulus data and response data can be stored in one or more storage devices 1020 (e.g., stimulus data store 1024, response data store 236, etc.). The measurement server 110 can further comprise a model generator 1004 that can use the stimulus data, response data, and/or other data to generate the stimulus attribution predictive model 162. In some embodiments, the model parameters (e.g., stimulus attribution predictive model parameters 176) characterizing the stimulus attribution predictive model 162 can be stored in the measurement data store 264. The measurement server 110 can further determine certain sets of touchpoint attributes (e.g., touchpoint attribute records 177) derived from the stimulus data and/or response data (see operation 1006).

As shown, the apportionment server 111 can receive the predictive model parameters and touchpoint attributes from the measurement server 110 (see operation 1008). An instance of the simulator 164 operating on the apportionment server 111 can determine one or more sets of media performance parameters (e.g., fractional attribution, etc.) based in part on the received model parameters and/or touchpoint attributes (see operation 1036). An instance of the media spend scenario planner 165 operating on the apportionment server 111 can further determine one or more sets of allocated media buy parameters (e.g., fractional spend allocations, etc.) based in part on the received model parameters and/or touchpoint attributes (see operation 1038). In some cases, the media spend scenario planner 165 can also use media spend allocations (e.g., stored in planning data store 1027) specified by a marketing manager (e.g., using the media planning application 105 on the management interface device 114) to determine the allocated media buy parameters. An instance of the media buy feed generator 168 might then use the media performance parameters and/or the allocated media buy parameters to generate one or more sets of media buy execution feed parameters (see operation 1040). In some cases, the media buy feed generator 168 can also use feed configuration parameters (e.g., stored in feed configurations 166) specified by a marketing manager (e.g., using the media planning application 105 on the management interface device 114) to determine the media buy execution feed parameters. Such media buy execution feed parameters can be structured to produce attribution-informed feeds delivered to the programmatic media buying execution platforms 192 according to the herein disclosed techniques.

The subsystem 10A00 presents merely one partitioning. The specific example shown where the measurement server 110 comprises the model generator 1004, and where the apportionment server 111 comprises the simulator 164, the media spend scenario planner 165, and the media buy feed generator 168 is purely exemplary, and other partitioning is reasonable, and the partitioning may be defined in part by the volume of empirical data. In some cases, a database engine can serve to perform calculations (e.g., within, or in conjunction with a database engine query). Such systems, subsystems, and partitionings can be used to implement the herein disclosed techniques. For example, certain instances of stimuli 152 and responses 154 associated with a current period can be used to dynamically generate (e.g., “refresh”) media buy execution feed parameters for media buying at the programmatic media buying execution platforms 192 that is optimized (e.g., improved ROI) as compared to media buying in historical periods, at least in as much as indicated by the predicted media performance associated with the current period. An embodiment of a technique for refreshing the attribution-informed media buy execution feeds used for dynamic media buy optimization is shown in FIG. 10B.

FIG. 10B presents a feed refresh technique 10B00 for dynamic media buy optimization using attribution-informed media buy execution feeds. As an option, one or more instances of feed refresh technique 10B00 or any aspect thereof may be implemented in the context of the architecture and functionality of the embodiments described herein. Also, the feed refresh technique 10B00 or any aspect thereof may be implemented in any desired environment.

The feed refresh technique 10B00 presents one embodiment of certain steps for refreshing the attribution-informed media buy execution feeds used for dynamic media buy optimization according to the herein disclosed techniques. In one or more embodiments, the steps and underlying operations shown in the feed refresh technique 10B00 can be executed by the measurement server 110 and/or the apportionment server 111 disclosed herein. As shown, the feed refresh technique 10B00 can commence with the invoking of a feed refresh cycle (see operation 1042). For example, a feed refresh cycle (e.g., feed refresh cycle 194) might be invoked responsive to receiving a certain volume of stimulus data and/or response data following an earlier feed generation event. Further, a feed refresh cycle can be responsive to a refresh cycle signal such as a signal triggered by a feed configuration schedule.

In some cases, interpolated performance parameters and/or interpolated media buy parameters might be used to refresh the feeds (see “Yes” path of decision 1044). In such cases, the interpolated media performance parameters in a current period (e.g., refresh cycle period) can be interpolated from the media performance parameters in a historical period (e.g., last refresh cycle period) (see operation 1048). Further, the interpolated allocated media buy parameters in a current period (e.g., refresh cycle period) can be interpolated from the allocated media buy parameters in a historical period (e.g., last refresh cycle period) (see operation 1050). In other cases, interpolation might not be required (see “No” path of decision 1044), yet an updated set of data records can be collected for the feed refresh (see operation 1046). For example, such updated input data might comprise stimulus data, response data, configuration data, media spend allocation data, and/or other data corresponding to a current period (e.g., refresh cycle period). The updated input data for the refresh cycle period can be used to determine a set of updated media performance parameters (see operation 1036) and/or a set of updated allocate media buy parameters (see operation 1038).

The feed refresh technique 10B00 can use the foregoing updated media performance parameters, updated allocate media buy parameters, interpolated media performance parameters, and/or interpolated allocate media buy parameters, as appropriate, to generate the media buy execution feed parameters associated with the feed refresh cycle (see operation 1040). Such media buy execution feed parameters can be delivered in one or more media buy execution feeds to one or more programmatic media buying execution platforms and/or other data consumers according to the herein disclosed techniques (see operation 1052) for use in executing media buys (see operation 1054). In one or more embodiments, the configuration (e.g., structure, schedule, etc.) of such media buy execution feeds can be characterized by feed configuration parameters (e.g., feed configuration parameters 182 stored in feed configurations 166) specified by an application user (e.g., marketing manager) using the media planning application 105. Various user interfaces for interacting with such an application are shown in the following.

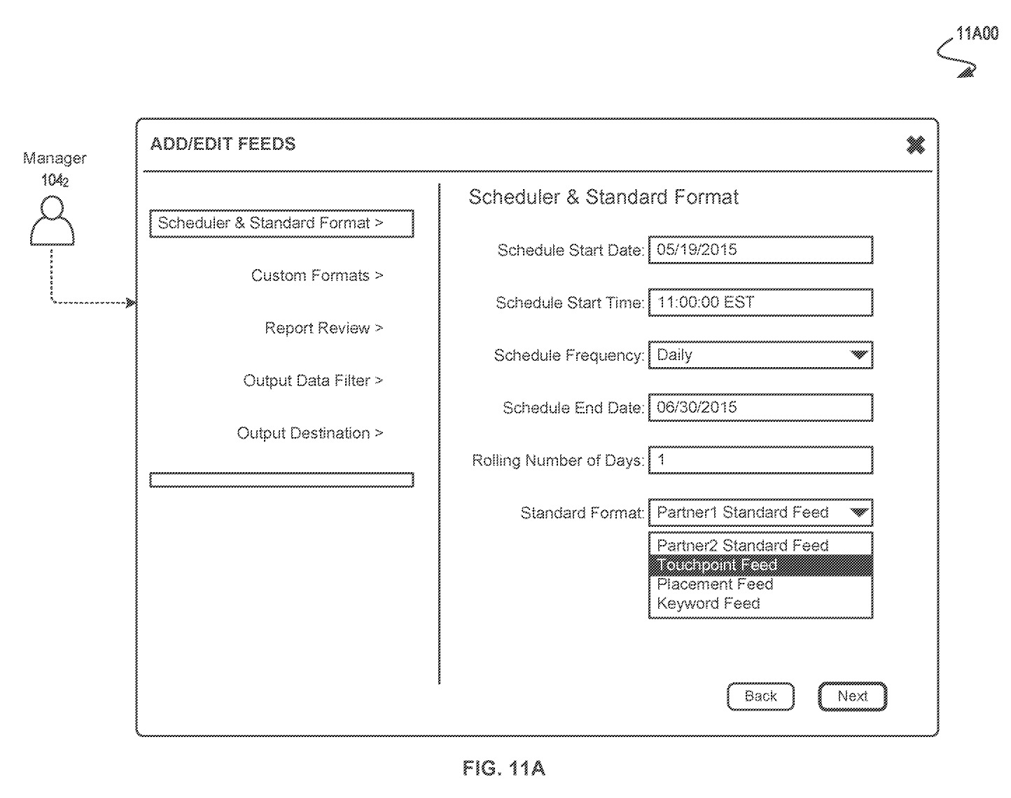

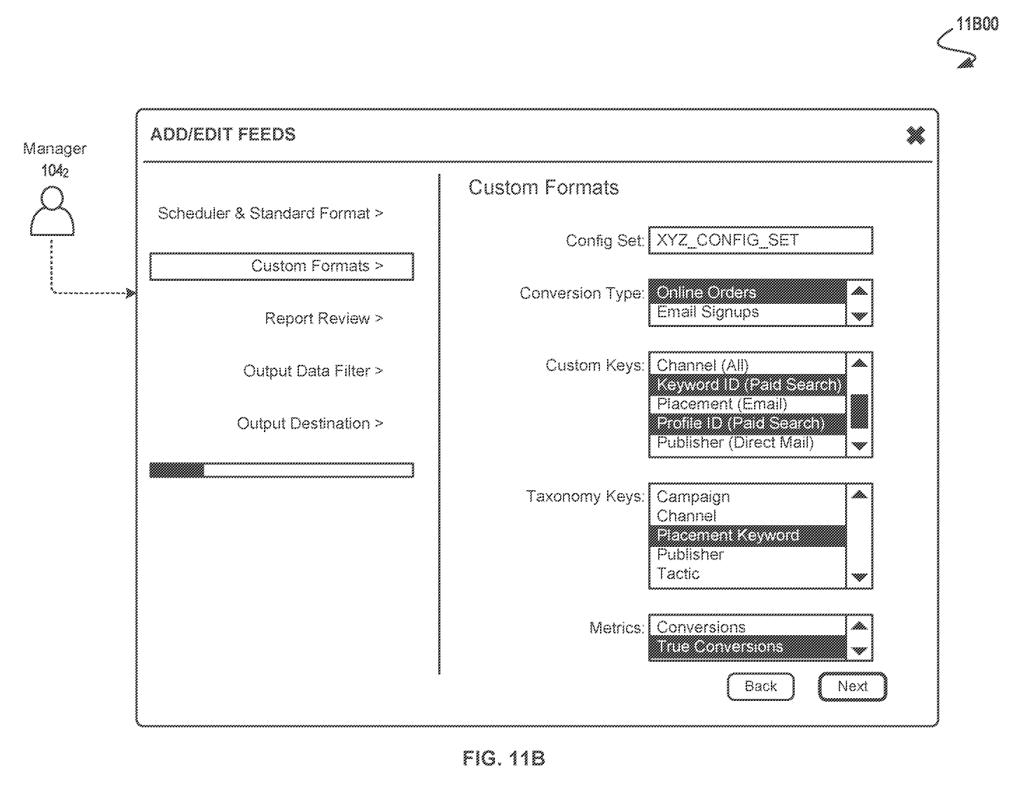

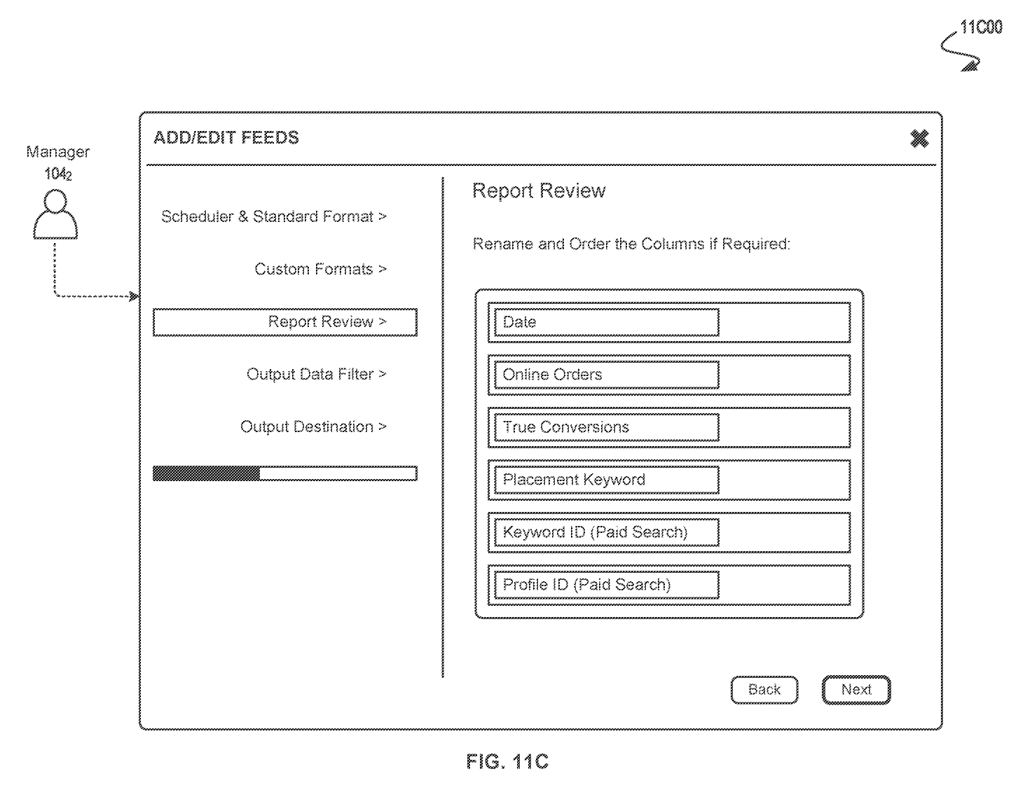

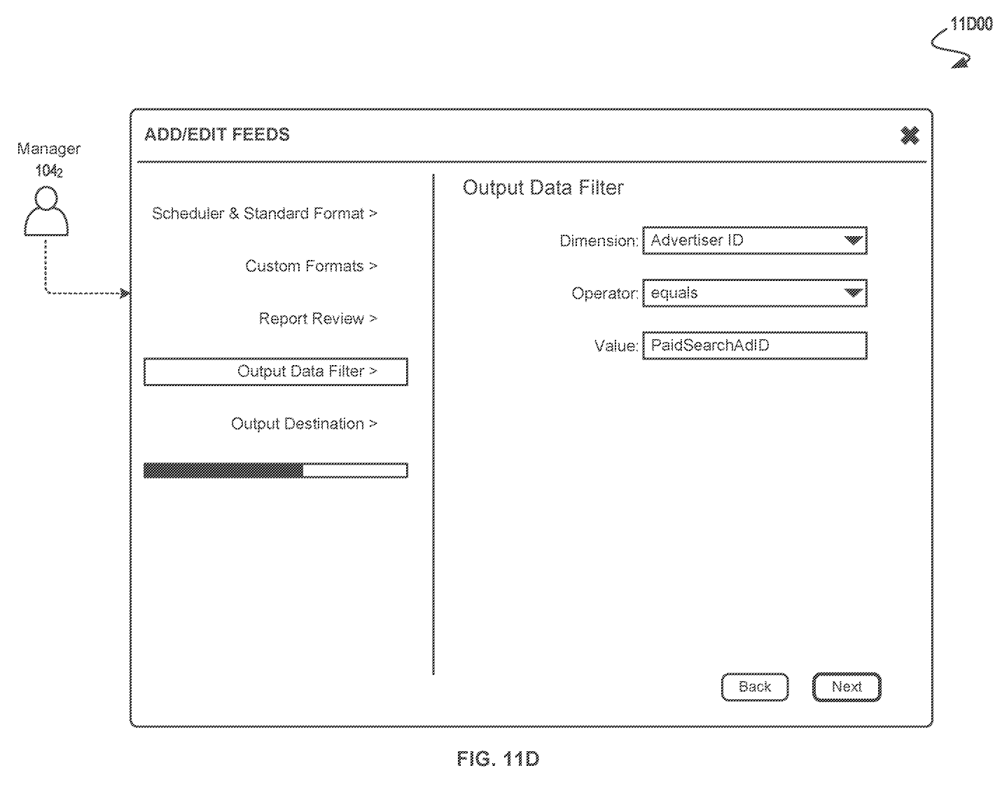

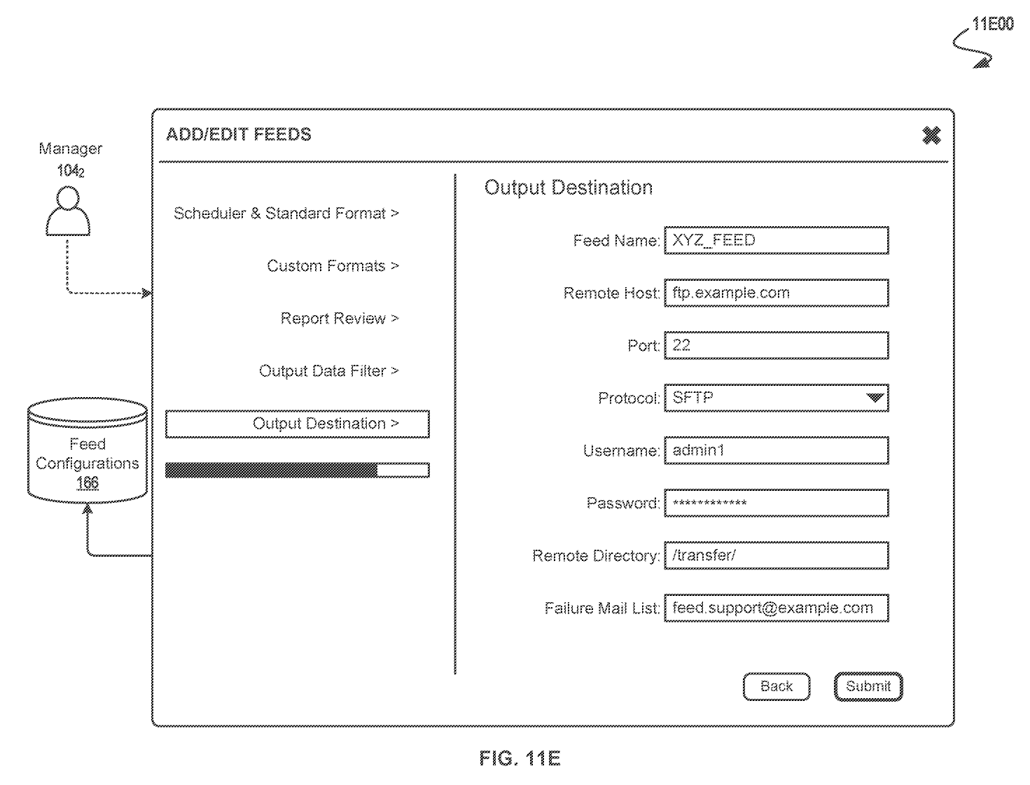

FIG. 11A presents a feed schedule interface 11A00 used in systems for dynamic media buy optimization using attribution-informed media buy execution feeds. As an option, one or more instances of feed schedule interface 11A00 or any aspect thereof may be implemented in the context of the architecture and functionality of the embodiments described herein. Also, the feed schedule interface 11A00 or any aspect thereof may be implemented in any desired environment.

In one or more embodiments, the feed schedule interface 11A00 can enable an application user (e.g., manager 104₂) to specify certain feed schedule and/or format configuration parameters used in systems for dynamic media buy optimization using attribution-informed media buy execution feeds. Specifically, as shown, the manager 104₂ might invoke a “Scheduler & Standard Format” step of a feed setup wizard to specify certain feed configuration parameters associated with the feed schedule, format, and/or other characteristics. More specifically, the manager 104₂ might specify a schedule start date, a schedule start time, a schedule frequency (e.g., daily, weekly, monthly, etc.), a schedule end date, a rolling number of days (e.g., up to 90 days), a standard format (e.g., partner-specific standard feed, touchpoint feed, placement feed, keyword feed, etc.), and/or other parameters. For example, a standard format might be represented by the attribution-informed placement feed data structure 4A00, or the attribution-informed touchpoint feed data structure 4B00.

FIG. 11B presents a feed format interface 11B00 used in systems for dynamic media buy optimization using attribution-informed media buy execution feeds. As an option, one or more instances of feed format interface 11B00 or any aspect thereof may be implemented in the context of the architecture and functionality of the embodiments described herein. Also, the feed format interface 11B00 or any aspect thereof may be implemented in any desired environment.

In one or more embodiments, the feed format interface 11B00 can enable an application user (e.g., manager 104₂) to specify certain feed custom format configuration parameters used in systems for dynamic media buy optimization using attribution-informed media buy execution feeds. Specifically, as shown, the manager 104₂ might invoke a “Custom Format” step of a feed setup wizard to specify certain feed configuration parameters associated with the feed format and/or other characteristics. More specifically, the manager 104₂ might specify a config set name, a conversion type (e.g., online orders, email signups, etc.), a selection of custom keys (e.g., channel, keyword ID, placement, profile ID, publisher, etc.), a selection of taxonomy keys (e.g., campaign, channel, placement keyword, publisher, tactic, etc.), a selection of metrics (e.g., conversions, true conversions, etc.), and/or other parameters. For example, the custom keys might comprise one or more of the earlier described tracking IDs.

FIG. 11C presents a feed report interface 11C00 used in systems for dynamic media buy optimization using attribution-informed media buy execution feeds. As an option, one or more instances of feed report interface 11C00 or any aspect thereof may be implemented in the context of the architecture and functionality of the embodiments described herein. Also, the feed report interface 11C00 or any aspect thereof may be implemented in any desired environment.

In one or more embodiments, the feed report interface 11C00 can enable an application user (e.g., manager 104₂) to specify certain feed report structure configuration parameters used in systems for dynamic media buy optimization using attribution-informed media buy execution feeds. Specifically, as shown, the manager 104₂ might invoke a “Report Review” step of a feed setup wizard to specify certain feed configuration parameters associated with the structure of the feed delivered (e.g., reported) to a given data consumer (e.g., DSP). More specifically, the manager 104₂ might specify an arrangement of certain feed configuration parameters organized as columns in a table structure. As shown, the manager 104₂ might specify table columns associated with a date, a conversion type (e.g., online orders), a metric (e.g., true conversions), a taxonomy key (e.g., placement keyword), a first custom key (e.g., keyword ID), and a second custom key (e.g., profile ID).

FIG. 11D presents a feed filter interface 11D00 used in systems for dynamic media buy optimization using attribution-informed media buy execution feeds. As an option, one or more instances of feed filter interface 11D00 or any aspect thereof may be implemented in the context of the architecture and functionality of the embodiments described herein. Also, the feed filter interface 11D00 or any aspect thereof may be implemented in any desired environment.

In one or more embodiments, the feed filter interface 11D00 can enable an application user (e.g., manager 104₂) to specify certain feed filtering configuration parameters used in systems for dynamic media buy optimization using attribution-informed media buy execution feeds. Specifically, as shown, the manager 104₂ might invoke an “Output Data Filter” step of a feed setup wizard to specify certain feed configuration parameters associated with feed data filters and/or other characteristics. More specifically, the manager 104₂ might specify a filter rule that comprises certain conditional statements that can be used to select a subset of a corpus of media buy execution feed parameters for inclusion in a given feed. For example, as shown, the manager 104₂ might specify an output data filter that selects feed data that corresponds to the rule “Advertiser ID”=“PaidSearchAdID”.

FIG. 11E presents a feed destination interface 11E00 used in systems for dynamic media buy optimization using attribution-informed media buy execution feeds. As an option, one or more instances of feed destination interface 11E00 or any aspect thereof may be implemented in the context of the architecture and functionality of the embodiments described herein. Also, the feed destination interface 11E00 or any aspect thereof may be implemented in any desired environment.

In one or more embodiments, the feed destination interface 11E00 can enable an application user (e.g., manager 104₂) to specify certain feed destination configuration parameters used in systems for dynamic media buy optimization using attribution-informed media buy execution feeds. Specifically, as shown, the manager 104₂ might invoke an “Output Destination” step of a feed setup wizard to specify certain feed configuration parameters associated with the feed destination and/or other characteristics. More specifically, the manager 104₂ might specify a feed name, a remote host URL, a networking port identifier, a protocol (e.g., SFTP, FTP, HTTP, JSON, etc.), a username, a password (e.g., for secure destinations), a remote directory, a failure mail list, and/or other parameters. In some cases, the “Output Destination” step in the wizard might be the last step, and clicking “Submit” can save the foregoing feed configuration parameters as an instance of the feed configurations 166.

### Additional Practical Application Examples

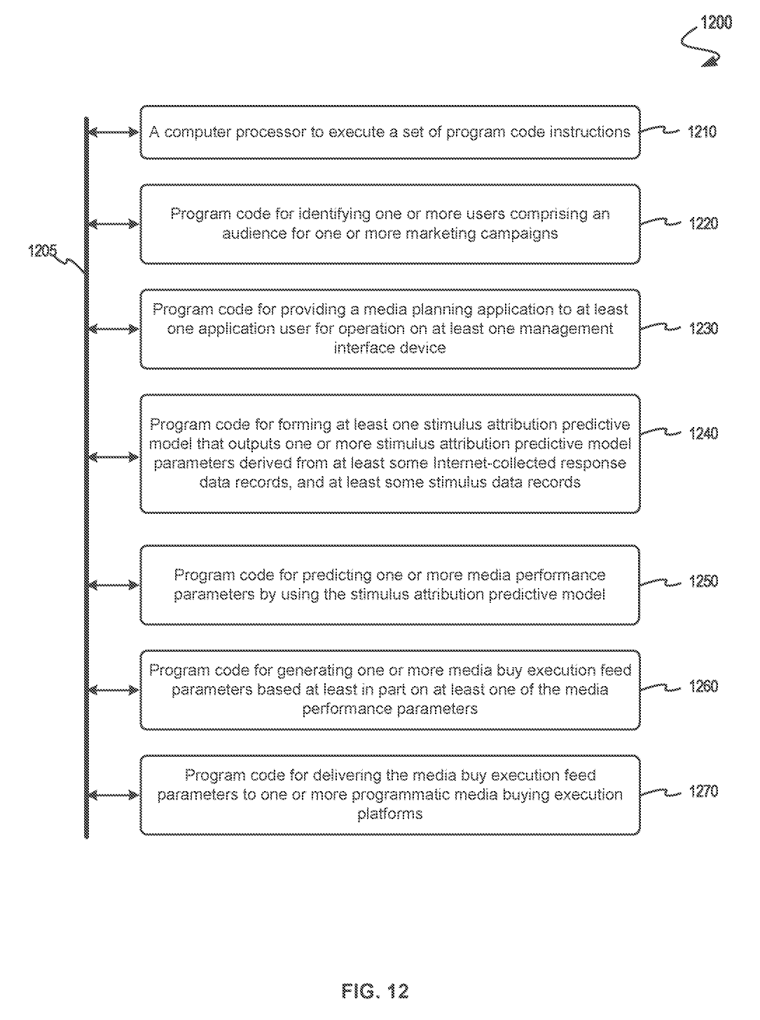

FIG. 12 is a block diagram of a system for dynamic media buy optimization using attribution-informed media buy execution feeds. As an option, the present system 1200 may be implemented in the context of the architecture and functionality of the embodiments described herein. Of course, however, the system 1200 or any operation therein may be carried out in any desired environment. The system 1200 comprises at least one processor and at least one memory, the memory serving to store program instructions corresponding to the operations of the system. As shown, an operation can be implemented in whole or in part using program instructions accessible by a module. The modules are connected to a communication path 1205, and any operation can communicate with other operations over communication path 1205. The modules of the system can, individually or in combination, perform method operations within system 1200. Any operations performed within system 1200 may be performed in any order unless as may be specified in the claims. The shown embodiment implements a portion of a computer system, presented as system 1200, comprising a computer processor to execute a set of program code instructions (see module 1210) and modules for accessing memory to hold program code instructions to perform: identifying one or more users comprising an audience for one or more marketing campaigns (see module 1220); providing a media planning application to at least one application user for operation on at least one management interface device (see module 1230); forming at least one stimulus attribution predictive model that outputs one or more stimulus attribution predictive model parameters derived from at least some Internet-collected response data records, and at least some stimulus data records (see module 1240); predicting one or more media performance parameters by using the stimulus attribution predictive model (see module 1250); generating one or more media buy execution feed parameters based at least in part on at least one of the media performance parameters such as quantifications of spending amounts for respective marketing message placements, and such as spending amounts that are based at least in part on effectiveness metrics, (see module 1260); and delivering the media buy execution feed parameters to one or more programmatic media buying execution platforms (see module 1270).

### Additional System Architecture Examples

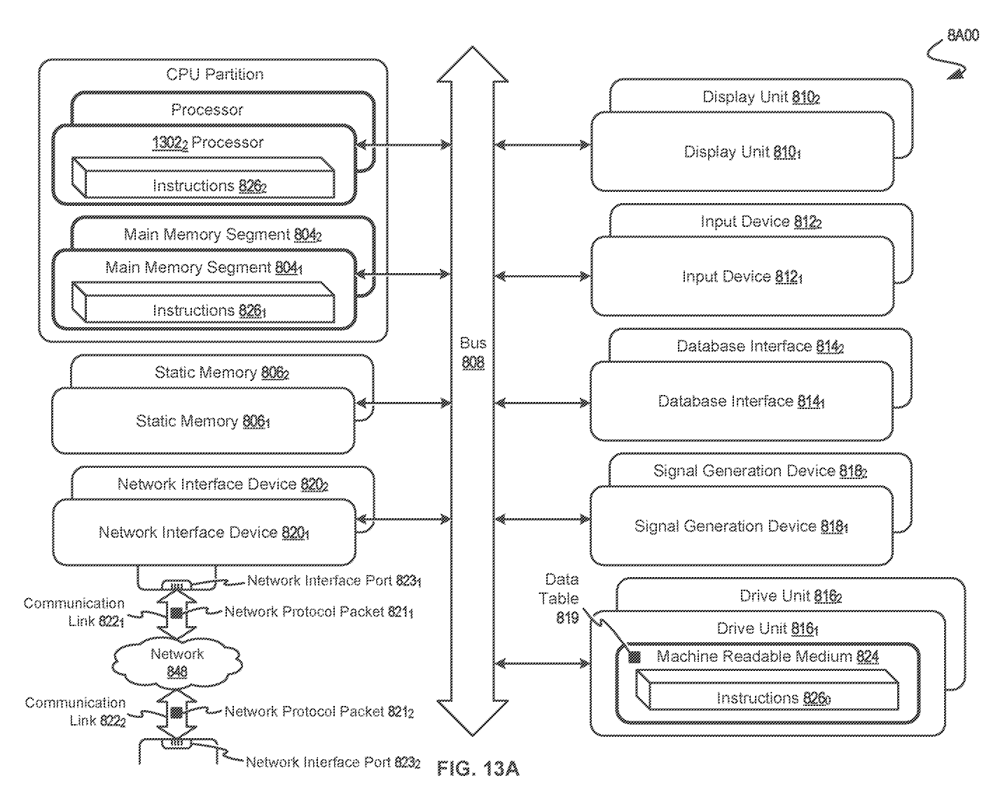

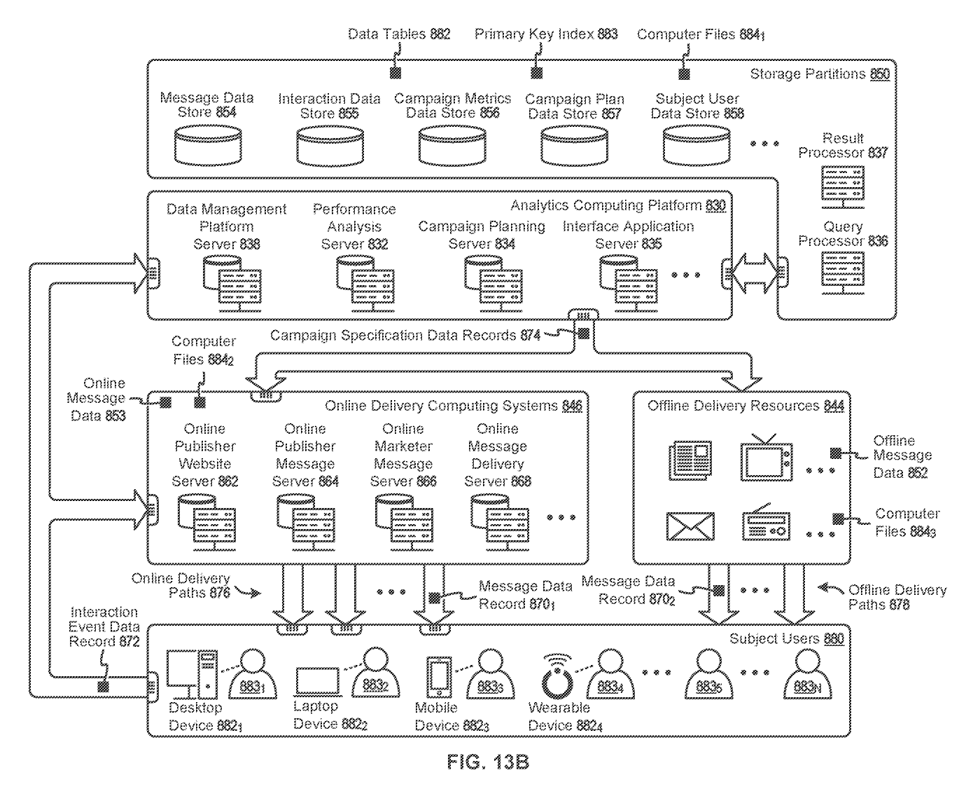

FIG. 13A depicts a diagrammatic representation of a machine in the exemplary form of a computer system 8A00 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 8A00 includes one or more processors (e.g., processor 802₁, processor 802₂, etc.), a main memory comprising one or more main memory segments (e.g., main memory segment 804₁, main memory segment 804₂, etc.), one or more static memories (e.g., static memory 806₁, static memory 806₂, etc.), which communicate with each other via a bus 808. The computer system 8A00 may further include one or more video display units (e.g., display unit 810₁, display unit 810₂, etc.), such as an LED display, or a liquid crystal display (LCD), or a cathode ray tube (CRT). The computer system 8A00 can also include one or more input devices (e.g., input device 812₁, input device 812₂, alphanumeric input device, keyboard, pointing device, mouse, etc.), one or more database interfaces (e.g., database interface 814₁, database interface 814₂, etc.), one or more disk drive units (e.g., drive unit 816₁, drive unit 816₂, etc.), one or more signal generation devices (e.g., signal generation device 818₁, signal generation device 818₂, etc.), and one or more network interface devices (e.g., network interface device 820₁, network interface device 820₂, etc.).

The disk drive units can include one or more instances of a machine-readable medium 824 on which is stored one or more instances of a data table 819 to store electronic information records. The machine-readable medium 824 can further store a set of instructions 826₀ (e.g., software) embodying any one, or all, of the methodologies described above. A set of instructions 826₁ can also be stored within the main memory (e.g., in main memory segment 804₁). Further, a set of instructions 826₂ can also be stored within the one or more processors (e.g., processor 802₁). Such instructions and/or electronic information may further be transmitted or received via the network interface devices at one or more network interface ports (e.g., network interface port 823₁, network interface port 823₂, etc.). Specifically, the network interface devices can communicate electronic information across a network using one or more optical links, Ethernet links, wireline links, wireless links, and/or other electronic communication links (e.g., communication link 822₁, communication link 822₂, etc.). One or more network protocol packets (e.g., network protocol packet 821₁, network protocol packet 821₂, etc.) can be used to hold the electronic information (e.g., electronic data records) for transmission across an electronic communications network (e.g., network 848). In some embodiments, the network 848 may include, without limitation, the web (i.e., the Internet), one or more local area networks (LANs), one or more wide area networks (WANs), one or more wireless networks, and/or one or more cellular networks.

The computer system 8A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM), random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 802₁, processor 802₂, etc.).

FIG. 13B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 848) using one or more electronic communication links (e.g., communication link 822₁, communication link 822₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 823₁, network interface port 823₂, etc.). In one or more embodiments, one or more network protocol packets (e.g., network protocol packet 821₁, network protocol packet 821₂, etc.) can be used to hold the electronic information comprising the signals.

As shown, the data processing system can be used by one or more advertisers to target a set of subject users 880 (e.g., user 883₁, user 883₂, user 883₃, user 883₄, user 883₅, to user 883_{N}) in various marketing campaigns. The data processing system can further be used to determine, by an analytics computing platform 830, various characteristics (e.g., performance metrics, etc.) of such marketing campaigns.

In some embodiments, the interaction event data record 872 comprises bottom up data suitable for computing, in performance analysis server 832, bottom up attribution. In other embodiments, the interaction event data record 872 and offline message data 852 comprise top down data suitable for computing, in performance analysis server 832, top down attribution. In yet other embodiments, the interaction event data record 872 and offline message data 852 comprises data suitable for computing, in performance analysis server 832, both bottom up and top down attribution.

The interaction event data record 872 comprises, in part, a plurality of touchpoint encounters that represent the subject users 880 exposure to marketing message(s). Each of these touchpoint encounters comprises a number of attributes, and each attribute comprises an attribute value. For example, the time of day during which the advertisement appeared, the frequency with which it was repeated, and the type of offer being advertised are all examples of attributes for a touchpoint encounter. Each attribute of a touchpoint may have a range of values. The attribute value range may be fixed or variable. For example, the range of attribute values for a day of the week attribute would be seven, whereas the range of values for a weather attribute may depend on the level of specificity desired. The attribute values may be objective (e.g., timestamp) or subjective (e.g., the relevance of the advertisement to the day's news cycle). For a “Publisher” attribute example (i.e., publisher of the marketing message), some examples of attribute values may be “Yahoo! Inc.”, “WSI.com”, “Seeking Alpha”, “NY Times Online”, “CBS Matchwatch”, “MSN Money”, “CBS Interactive”, “YuMe” and “IH Remnant.”

The interaction event data record 872 may pertain to various touchpoint encounters for an advertising or marketing campaign and the subject users 880 who encountered each touchpoint. The interaction event data record 872 may include entries that list each instance of a consumer's encounter with a touchpoint and whether or not that consumer converted. The interaction event data record 872 may be gathered from a variety of sources, such as Internet advertising impressions and responses (e.g., instances of an advertisement being serve to a user and the user's response, such as clicking on the advertisement). Offline message data 852, such as conversion data pertaining to television, radio, or print advertising, may be obtained from research and analytics agencies or other external entities that specialize in the collection of such data.

According to one embodiment, to compute bottom up attribution in performance analysis server 832, the raw touchpoint and conversion data (e.g., interaction event data record 872 and offline message data 852) is prepared for analysis. For example, the data may be grouped according to touchpoint, user, campaign, or any other scheme that facilitates ease of analysis. All of the subject users 880 that encountered the various touchpoints of a marketing campaign are identified. The subject users 880 are divided between those who converted (i.e., performed a desired action as a result of the marketing campaign) and those who did not convert, and the attributes and attribute values of each touchpoint encountered by the subject users 880 are identified. Similarly, all of the subject users 880 that converted are identified. For each touchpoint encounter, this set of users is divided between those who encountered the touchpoint and those who did not. Using this data, the importance of each attribute of the various advertising touchpoints is determined, and the attributes of each touchpoint are ranked according to importance. Similarly, for each attribute and attribute value of each touchpoint, the likelihood that a potential value of that attribute might influence a conversion is determined.

According to some embodiments, attribute importance and attribute value importance may be modeled, using machine-learning techniques, to generate weights that are assigned to each attribute and attribute value, respectively. In some embodiments, the weights are determined by comparing data pertaining to converting users and non-converting users. In other embodiments, the attribute importance and attribute value importance may be determined by comparing conversions to the frequency of exposures to touchpoints with that attribute relative to others. In some embodiments, logistic regression techniques are used to determine the influence of each attribute and to determine the importance of each potential value of each attribute. Any machine-learning algorithm may be used without deviating from the spirit or scope of the invention.

An attribution algorithm is used and coefficients are assigned for the algorithm, respectively, using the attribute importance and attribute value importance weights. The attribution algorithm determines the relative effect of each touchpoint in influencing each conversion given the attribute weights and the attribute value weights. The attribution algorithm is executed using the coefficients or weights. According to one embodiment, for each conversion, the attribution algorithm outputs a score for every touchpoint that a user encountered prior to converting, wherein the score represents the touchpoint's relative influence on the user's decision to convert. The attribution algorithm, which calculates the contribution of the touchpoint to the conversion, may be expressed as a function of the attribute importance (e.g., attribute weights) and attribute value lift (e.g., attribute value weights):

Credit Fraction=Σₐ₌ₙf(attribute importanceₐ,attribute value liftₐ)

wherein, “a” represents the attribute and “n” represents the number of attributes. Further details regarding a general approach to bottom up touchpoint attribution are described in U.S. application Ser. No. 13/492,493 (Attorney Docket No. VISQ.P0001) entitled, “A METHOD AND SYSTEM FOR DETERMINING TOUCHPOINT ATTRIBUTION”, filed Jun. 8, 2012, now U.S. Pat. No. 9,183,562, the contents of which are incorporated by reference in its entirety in this application.

Performance analysis server 832 may also perform top down attribution. In general, a top down predictive model is used to determine the effectiveness of marketing stimulations in a plurality of marketing channels included in a marketing campaign. Data (interaction event data record 872 and Offline message data 852), comprising a plurality of marketing stimulations and respective measured responses, is used to determine a set of cross-channel weights to apply to the respective measured responses, where the cross-channel weights are indicative of the influence that a particular stimulation applied to a first channel has on the measure responses of other channels. The cross-channel weights are used in calculating the effectiveness of a particular marketing stimulation over an entire marketing campaign. The marketing campaign may comprise stimulations quantified as a number of direct mail pieces, a number or frequency of TV spots, a number of web impressions, a number of coupons printed, etc.

The top down predictive model takes into account cross-channel influence from more spending. For example, the effect of spending more on TV ads might influence viewers to “log in” (e.g., to access a website) and take a survey or download a coupon. The top down predictive model also takes into account counter-intuitive cross-channel effects from a single channel model. For example, additional spending on a particular channel often suffers from measured diminishing returns (e.g., the audience “tunes out” after hearing a message too many times). Placement of a message can reach a “saturation point” beyond which point further desired behavior is not apparent in the measurements in the same channel. However additional spending beyond the single-channel saturation point may correlate to improvements in other channels.

One approach to advertising portfolio optimization uses marketing attributions and predictions determined from historical data (interaction event data record 872 and Offline message data 852). Analysis of the historical data serves to infer relationships between marketing stimulations and responses. In some cases, the historical data comes from “online” outlets, and is comprised of individual user-level data, where a direct cause-effect relationship between stimulations and responses can be verified. However, “offline” marketing channels, such as television advertising, are of a nature such that indirect measurements are used when developing models used in media spend optimization. For example, some stimuli are described as an aggregate (e.g., “TV spots on Prime Time News, Monday, Wednesday and Friday”) that merely provides a description of an event or events as a time-series of marketing stimulations (e.g., weekly television advertising spends). Responses to such stimuli are also often measured and/or presented in aggregate (e.g., weekly unit sales reports provided by the telephone sales center). Yet, correlations, and in some cases causality and inferences, between stimulations and responses can be determined via statistical methods.

The top down predictive model considers cross-channel effects even when direct measurements are not available. The top down predictive model may be formed using any machine learning techniques. Specifically, top down predictive model may be formed using techniques where variations (e.g., mixes) of stimuli are used with the learning model to capture predictions of what would happen if a particular portfolio variation were prosecuted. The learning model produces a set of predictions, one set of predictions for each variation. In this manner, variations of stimuli produce predicted responses, which are used in weighting and filtering, which in turn result in a simulated model being output that includes cross-channel predictive capabilities.

In one example, a portfolio schematic includes three types of media, namely TV, radio and print media. Each media type may have one or more spends. For example, TV may include stations named CH1 and CH2. Radio includes a station named KVIQ 212. Print media may comprise distribution in the form of mail, a magazine and/or a printed coupon. For each media, there is one or more stimulations (e.g., S1, S2, . . . SN) and its respective response (e.g., R1, R2, R3 . . . RN). There is a one-to-one correspondence between a particular stimulus and its response. The stimuli and responses discussed herein are often formed as a time-series of individual stimulations and responses, respectively. For notational convenience, a time-series is given as a vector, such as vector S1.

Continuing the discussion of the example portfolio, the portfolio includes spends for TV, such as the evening news, weekly series, and morning show. The portfolio also includes radio spends in the form of a sponsored public service announcement, a sponsored shock jock spot, and a contest. The example portfolio may further include spends for radio station KVIQ, a direct mailer, and magazine print ads (e.g., coupon placement). The portfolio also includes spends for print media in the form of coupons.

The example portfolio may be depicted as stimulus vectors (e.g., S1, S2, S3, S4, S5, S6, S7, S8, and S). The example portfolio may also show a set of response measurements to be taken, such as response vectors (e.g., R1, R2, R3, R4, R5, R6, R7, R8, and RN).

A vector S̅1̅ may be comprised of a time-series. The time-series may be presented in a native time unit (e.g., weekly, daily) and may be apportioned over a different time unit. For example, stimulus S1 corresponds to a weekly spend for “Prime Time News” even though the stimulus to be considered actually occurs nightly (e.g., during “Prime Time News”). The weekly spend stimulus can be apportioned to a nightly stimulus occurrence. In some situations, the time unit in a time-series can be very granular (e.g., by the minute). Apportioning can be performed using any known techniques. Stimulus vectors and response vectors can be formed from any time-series in any time units and can be apportioned to another time-series using any other time units.

A particular stimulus in a first marketing channel (e.g., S̅1̅) might produce corresponding results (e.g., R̅1̅). Additionally, a stimulus in a first marketing channel (e.g., S̅1̅) might produce results (or lack of results) as given by measured results in a different marketing channel (e.g., R̅3̅) Such correlation of results, or lack of results, can be automatically detected, and a scalar value representing the extent of correlation can be determined mathematically from any pair of vectors. In the discussions just below, the correlation of a time-series response vector is considered with respect to a time-series stimulus vector. Correlations can be positive (e.g., the time-series data moves in the same directions), or negative (e.g., the time-series data moves in the opposite directions), or zero (no correlation).

An example vector S̅1̅ is comprised of a series of changing values. The response R̅1̅ may be depicted as a curve. Maximum value correlation occurs when the curve is relatively time-shifted, by Δt amount of time, to another. The amount of correlation and amount of time shift can be automatically determined. Example cross-channel correlations are presented in Table 1.

TABLE 1
Cross-correlation examples

| Stimulus Channel →Cross- | |
|---|---|
| channel | Description |
| S1 → R2 | No correlation. |
| S1 → R3 | Correlates if time shifted and attenuated |
| S1 → R4 | Correlates if time shifted and amplified |

In some cases, a correlation calculation can identify a negative correlation where an increase in a first channel causes a decrease in a second channel. Further, in some cases, a correlation calculation can identify an inverse correlation where a large increase in a first channel causes a small increase in a second channel. In still further cases, there can be no observed correlation, or in some cases correlation is increased when exogenous variables are considered.

In some cases a correlation calculation can hypothesize one or more causation effects. And in some cases correlation conditions are considered when calculating correlation such that a priori known conditions can be included (or excluded) from the correlation calculations.

The automatic detection can proceed autonomously. In some cases correlation parameters are provided to handle specific correlation cases. In one case, the correlation between two time-series can be determined to a scalar value using Eq. 1

$$r = \frac{{n \sum }^{ } xy - ( {\sum }^{ } x ) ( {\sum }^{ } y )}{\sqrt{{n ( \sum }^{ } {x}^{3} ) - {( {\sum }^{ } x )}^{3} \sqrt{{n ( \sum }^{ } {y}^{2} ) - {( {\sum }^{ } y )}^{3}}}} \qquad ( 1 )$$

where:

x represents components of a first time-series,

y represents components of a second time-series, and

n is the number of {x, y} pairs.

In some cases, while modeling a time-series, not all the scalar values in the time-series are weighted equally. For example, more recent time-series data values found in the historical data are given a higher weight as compared to older ones. Various shapes of weights to overlay a time-series are possible, and one exemplary shape is the shape of an exponentially decaying model.

Use of exogenous variables might involve considering seasonality factors or other factors that are hypothesized to impact, or known to impact, the measured responses. For example, suppose the notion of seasonality is defined using quarterly time graduations And the measured data shows only one quarter (e.g., the 4^{th} quarter) from among a sequence of four quarters in which a significant deviation of a certain response is present in the measured data in such a case, the exogenous variables 58 can define a variable that lumps the 1^{st} through 3^{rd} quarters into one variable and the 4^{th} quarter in a separate variable.

Further details of a top down predictive model are described in U.S. application Ser. No. 14/145,625 (Attorney Docket No. VISQ.P0004) entitled. “MEDIA SPEND OPTIMIZATION USING CROSS-CHANNEL PREDICTIVE MODEL”, filed Dec. 31, 2013, the contents of which are incorporated by reference in its entirety in this Application.

Other operations, transactions, and/or activities associated with the data processing system are possible Specifically, the subject users 880 can receive a plurality of online message data 853 transmitted through any of a plurality of online delivery paths 876 (e.g., online display, search, mobile ads, etc.) to various computing devices (e.g., desktop device 882₁, laptop device 882₂, mobile device 882₃, and wearable device 882₄) The subject users 880 can further receive a plurality of offline message data 852 presented through any of a plurality of offline delivery paths 878 (e.g., TV, radio, print, direct mail, etc.). The online message data 853 and/or the offline message data 852 can be selected for delivery to the subject users 880 based in part on certain instances of campaign specification data records 874 (e.g., established by the advertisers and/or the analytics computing platform 830). For example, the campaign specification data records 874 might comprise settings, rules, taxonomies, and other information transmitted electronically to one or more instances of online delivery computing systems 846 and/or one or more instances of offline delivery resources 844. The online delivery computing systems 846 and/or the offline delivery resources 844 can receive and store such electronic information in the form of instances of computer files 884₂ and computer files 884₃, respectively. In one or more embodiments, the online delivery computing systems 846 can comprise computing resources such as an online publisher website server 862, an online publisher message server 864, an online marketer message server 866, an online message delivery server 868, and other computing resources. For example, the message data record 870₁ presented to the subject users 880 through the online delivery paths 876 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 870₂ presented to the subject users 880 through the offline delivery paths 878 can be transmitted as sensory signals in various forms (e.g., printed pictures and text, video, audio, etc.).

The analytics computing platform 830 can receive instances of an interaction event data record 872 comprising certain characteristics and attributes of the response of the subject users 880 to the message data record 870₁, the message data record 870₂, and/or other received messages. For example, the interaction event data record 872 can describe certain online actions taken by the users on the computing devices, such as visiting a certain URL, clicking a certain link, loading a web page that fires a certain advertising tag, completing an online purchase, and other actions. The interaction event data record 872 may also include information pertaining to certain offline actions taken by the users, such as purchasing a product in a retail store, using a printed coupon, dialing a toll-free number, and other actions. The interaction event data record 872 can be transmitted to the analytics computing platform 830 across the communications links as instances of electronic data records using various protocols and structures. The interaction event data record 872 can further comprise data (e.g., user identifier, computing device identifiers, timestamps, IP addresses, etc.) related to the users and/or the users' actions.

The interaction event data record 872 and other data generated and used by the analytics computing platform 830 can be stored in one or more storage partitions 850 (e.g., message data store 854, interaction data store 855, campaign metrics data store 856, campaign plan data store 857, subject user data store 858, etc.). The storage partitions 850 can comprise one or more databases and/or other types of non-volatile storage facilities to store data in various formats and structures (e.g., data tables 882, computer files 884₁, etc.). The data stored in the storage partitions 850 can be made accessible to the analytics computing platform 830 by a query processor 836 and a result processor 837, which can use various means for accessing and presenting the data, such as a primary key index 883 and/or other means. In one or more embodiments, the analytics computing platform 830 can comprise a performance analysis server 832 and a campaign planning server 834. Operations performed by the performance analysis server 832 and the campaign planning server 834 can vary widely by embodiment. As an example, the performance analysis server 832 can be used to analyze the messages presented to the users (e.g., message data record 870₁ and message data record 870₂) and the associated instances of the interaction event data record 872 to determine various performance metrics associated with a marketing campaign, which metrics can be stored in the campaign metrics data store 856 and/or used to generate various instances of the campaign specification data records 874. Further, for example, the campaign planning server 834 can be used to generate marketing campaign plans and associated marketing spend apportionments, which information can be stored in the campaign plan data store 857 and/or used to generate various instances of the campaign specification data records 874. Certain portions of the interaction event data record 872 might further be used by a data management platform server 838 in the analytics computing platform 830 to determine various user attributes (e.g., behaviors, intent, demographics, device usage, etc.), which attributes can be stored in the subject user data store 858 and/or used to generate various instances of the campaign specification data records 874. One or more instances of an interface application server 835 can execute various software applications that can manage and/or interact with the operations, transactions, data, and/or activities associated with the analytics computing platform 830. For example, a marketing manager might interface with the interface application server 835 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer-implemented method, comprising:
storing in a computer platform, stimuli data for a plurality of touchpoint encounters that represent exposure to a plurality of messages, transmitted through a network, to a plurality of users that receive the messages on a plurality of user devices, wherein the touchpoint encounters comprise attributes that define a plurality of universal unique identifiers (UUIDs) for the user devices and at least one cross-device user engagement stack that consolidates at least two of the touchpoint encounters from at least two of the user devices with different UUIDs and associated with a single user,
storing, in the computer platform, response data for the touchpoint encounters that records both positive and negative responses to the messages;
training, using machine-learning techniques in a computer, the stimuli data with the cross-device user engagement stack and the response data to generate a stimulus attribution predictive model that outputs one or more attribution parameters to estimate an effectiveness of the messages to elicit the positive responses from the users;
generating one or more media buy execution feed parameters that quantify a set of spending amounts based on the attribution parameters, wherein one of the spending amounts specify a cost-effective amount to deliver one of the messages to the users; and
delivering the media buy execution feed parameters to one or more programmatic media buying execution platforms that attempt to deliver the messages in accordance with the spending amounts.

2. The computer-implemented method as set forth in claim 1, wherein the messages exposed to a plurality of users comprise notification messages associated with an Internet of Things system.

3. The computer-implemented method as set forth in claim 1, wherein the messages exposed to a plurality of users comprise marketing messages deployed across a plurality of media channels.

4. The computer-implemented method as set forth in claim 3, wherein the media buy execution feed parameters comprise one or more interpolated media buy execution feed parameters that correspond to a current period derived from one or more historical periods.

5. The computer-implemented method as set forth in claim 3, wherein the media buy execution feed parameters comprise one or more media buy execution feed parameters determined at least in part from a management interface device.

6. The computer-implemented method as set forth in claim 3, wherein the marketing message comprises at least one of, an online advertisement, a banner ad, a television spot, a radio spot, or a direct mailer event.

7. The computer-implemented method as set forth in claim 3, wherein the media buy execution feed parameters conform, at least in part, to an output format specified as a “Marin Standard Feed”, as a “Kenshoo Standard Feed”, as a “Turn Placement Feed”, as a “Touchpoint Feed”, as a “Xasixs Placement Feed”, as a “Ziff Davis” feed, or any combination of formats therefrom.

8. A computer readable medium, embodied in a non-transitory computer readable medium, the non-transitory computer readable medium having stored thereon a sequence of instructions which, when stored in memory and executed by a processor causes the processor to perform a set of acts, the acts comprising:
storing in a computer platform, stimuli data for a plurality of touchpoint encounters that represent exposure to a plurality of messages, transmitted through a network, to a plurality of users that receive the messages on a plurality of user devices, wherein the touchpoint encounters comprise attributes that define a plurality of universal unique identifiers (UUIDs) for the user devices and at least one cross-device user engagement stack that consolidates at least two of the touchpoint encounters from at least two of the user devices with different UUIDs and associated with a single user;
storing, in the computer platform, response data for the touchpoint encounters that records both positive and negative responses to the messages;
training, using machine-learning techniques in a computer, the stimuli data with the cross-device user engagement stack and the response data to generate a stimulus attribution predictive model that outputs one or more attribution parameters to estimate an effectiveness of the messages to elicit the positive responses from the users;
generating one or more media buy execution feed parameters that quantify a set of spending amounts based on the attribution parameters, wherein one of the spending amounts specify a cost-effective amount to deliver one of the messages to the users; and
delivering the media buy execution feed parameters to one or more programmatic media buying execution platforms that attempt to deliver the messages in accordance with the spending amounts.

9. The computer readable medium as set forth in claim 8, wherein the messages exposed to a plurality of users comprise notification messages associated with an Internet of Things system.

10. The computer readable medium as set forth in claim 8, wherein the messages exposed to a plurality of users comprise marketing messages deployed across a plurality of media channels.

11. The computer readable medium as set forth in claim 10, wherein the media buy execution feed parameters comprise one or more interpolated media buy execution feed parameters that correspond to a current period derived from one or more historical periods.

12. The computer readable medium as set forth in claim 10, wherein the media buy execution feed parameters comprise one or more media buy execution feed parameters determined at least in part from a management interface device.

13. The computer readable medium as set forth in claim 10, wherein the marketing message comprises at least one of, an online advertisement, a banner ad, a television spot, a radio spot, or a direct mailer event.

14. The computer readable medium as set forth in claim 10, wherein the media buy execution feed parameters conform, at least in part, to an output format specified as a “Marin Standard Feed”, as a “Kenshoo Standard Feed”, as a “Turn Placement Feed”, as a “Touchpoint Feed”, as a “Xasixs Placement Feed”, as a “Ziff Davis” feed, or any combination of formats therefrom.

15. A system comprising:
a storage medium, having stored thereon, a sequence of instructions;
at least one processor, coupled to the storage medium, that executes the instructions to cause the processor to perform a set of acts comprising:
storing in a computer platform, stimuli data for a plurality of touchpoint encounters that represent exposure to a plurality of messages, transmitted through a network, to a plurality of users that receive the messages on a plurality of user devices, wherein the touchpoint encounters comprise attributes that define a plurality of universal unique identifiers (UUIDs) for the user devices and at least one cross-device user engagement stack that consolidates at least two of the touchpoint encounters from at least two of the user devices with different UUIDs and associated with a single user;
storing, in the computer platform, response data for the touchpoint encounters that records both positive and negative responses to the messages;
training, using machine-learning techniques in a computer, the stimuli data with the cross-device user engagement stack and the response data to generate a stimulus attribution predictive model that outputs one or more attribution parameters to estimate an effectiveness of the messages to elicit the positive responses from the users;
generating one or more media buy execution feed parameters that quantify a set of spending amounts based on the attribution parameters, wherein one of the spending amounts specify a cost-effective amount to deliver one of the messages to the users; and
delivering the media buy execution feed parameters to one or more programmatic media buying execution platforms that attempt to deliver the messages in accordance with the spending amounts.

16. The system as set forth in claim 15, wherein the messages exposed to a plurality of users comprise notification messages associated with an Internet of Things system.

17. The system as set forth in claim 15, wherein the messages exposed to a plurality of users comprise marketing messages deployed across a plurality of media channels.

18. The system as set forth in claim 17, wherein the media buy execution feed parameters comprise one or more interpolated media buy execution feed parameters that correspond to a current period derived from one or more historical periods.

19. The system as set forth in claim 17, wherein the media buy execution feed parameters comprise one or more media buy execution feed parameters determined at least in part from a management interface device.

20. The system as set forth in claim 17, wherein the marketing message comprises at least one of, an online advertisement, a banner ad, a television spot, a radio spot, or a direct mailer event.
